(19) United States
(12) Patent Application Publication
(10) Pub. No.: US 2011/0314138 A1
(43) Pub. Date: Dec. 22, 2011

(54) METHOD AND APPARATUS FOR CAUSE ANALYSIS CONFIGURATION CHANGE

(75) Inventors: Emiko Kobayashi, Yokohama (JP); Yutaka Kudo, Kawasaki (JP); Kiminori Sugauchi, Yokohama (JP); Tetsuya Masuishi, San Jose, CA (US); Takahiro Fujita, Sagamihara (JP); Yoshitsugu Ono, San Jose, CA (US)

(73) Assignee: HITACHI, LTD., Tokyo (JP)

(21) Appl. No.: 12/988,105

(22) PCT Filed: Jul. 7, 2010
(86) PCT No.: PCT/JP2010/061563

§ 371 Date: Oct. 15, 2010

(30) Foreign Application Priority Data
Jun. 21, 2010 (JP) 2010-140104

(51) Int. Cl. G06F 15/177

(52) U.S. Cl. 709/222

(57) ABSTRACT

In a computer system that comprises multiple target computers and an analysis computer, one or more first target computers, in which a predetermined application has been installed and invoked, send a log comprising information of multiple configuration changes that have been made prior to invoking the predetermined application to the analysis computer, and the analysis computer receives the log and computes, for each type of configuration change and based on the log, an invocation failure rate which is a percentage at which the invocation of the predetermined application fails subsequent to the configuration change. Then, a second target computer receives, from the analysis computer, first information comprising an invocation failure rate for each type of configuration change related to the predetermined application, and based on the invocation failure rate, displays the type of configuration change that is the cause of the failure of the predetermined application invocation.

### TECHNICAL FIELD

The present invention generally relates to a cause analysis in a computer, and more specifically, to a cause analysis accompanying a change in a configuration for finding a solution to an application failure without using a knowledge database by analyzing the configuration change.

### BACKGROUND ART

One of the most stressful jobs for an administrator of a desktop computing environment is the cause analysis (troubleshooting) of a case in which trouble has occurred. Cause analysis is also a deciding factor for help desk personnel, who must provide a caller with a solution. An end user tends to install numerous types of software and change OS settings, and this can create problems. In addition, the configuration of a computer can be changed without the end user realizing it due to the numerous upgrade programs that routinely run on the end user's computer. Therefore, there are cases where the end user does not know when a configuration fault occurred, and cannot recall when a problem arose. The administrator or help desk personnel of this type of desktop computing environment must use their specialized knowledge and deep understanding of what is behind the trouble to provide the end user with a solution.

Current solutions, for example, include technology for remotely examining event logs inside a computer, technology for collecting and storing configuration items and their change history, technology for detecting the invocation of an application and storing the invocation history, technology for storing knowledge about past solutions, and technology for deducing a root cause by combining the above-mentioned information.

Patent Literature 1 is an example of deducing a root cause using an event log, a configuration change, and a knowledge database. Paragraph 0134 discloses the collection of an error log, event information, and chronological data on configuration changes from a target monitoring computer. Paragraph 0137 and FIGS. 16, 17, and 18 disclose the comparison of an error status on a target computer with past data.

Examples of the remote collection of event logs include Patent Literature 2 and Patent Literature 3. Patent Literature 4 is an example of fault analysis using a knowledgebase. Patent Literature 5 is an example of fault analysis using an error log. Patent Literature 6 is an example of the remote acquisition of a configuration change.

### CITATION LIST

### Patent Literature

[PTL 1]
Japanese Patent Application Publication No. 2007-293393
[PTL 2]
U.S. Pat. No. 6,289,379
[PTL 3]
U.S. Pat. No. 5,857,190
[PTL 4]
U.S. Pat. No. 6,012,152
[PTL 5]
U.S. Pat. No. 6,598,179
[PTL 6]
US Patent Application Publication No. 2007/0214193 A1

### SUMMARY OF INVENTION

### Technical Problem

Either the administrator or the help desk personnel must possess knowledge of event logs, configuration change histories, and application invocation histories, and the know how to provide a solution by carefully examining these types of information. Knowledge can be obtained from a knowledge database that provides a “cause” and a “solution” described by another person. Someone must keep the knowledge database up-to-date, and this requires maintenance fees.

Another task of the present invention is to provide information for analyzing a software problem related to a configuration change without using the knowledgebase when the end user changes the configuration.

### Solution to Problem

An illustrative embodiment of the present invention provides a technique for determining which configuration change has caused a problem without the need for a knowledge database. Therefore, the present invention does not provide a root cause, but rather provides a “tolerance limit” that must be removed (that is, a final answer). Rather than being “root cause” oriented, the present invention provides a direct solution-oriented method for handling a problem.

The end user asks a question. The help desk starts an analysis. The initial step is to detect a target time period. In order to detect that target time period, a cause analysis program detects the last successful application invocation and the first application invocation failure based on both the event log and the application invocation history. With respect to the detection of a configuration change, the configuration change is determined by combining the configuration change history and the result of the target time period detection. These configuration changes may affect the invocation of an application. One of these configuration changes is the tolerance limit. The next step is to check another computer. To determine the configuration change that has the highest likelihood of being the cause, the cause analysis program checks other computers that have experienced the same configuration change. The cause analysis program checks and counts the results of application invocations before and after each configuration change. Upon discovering the same configuration change in another computer, the program checks whether the respective configuration changes caused the same problem in this computer, and whether the problem was fixed. The program counts similar cases for all the computers. Thereafter, the program computes the ratio of instances accompanying a change from success to failure and the ratio of instances accompanying a change from failure to success with respect to all the instances for the respective configuration changes. The cause analysis program displays these results thereafter. The results of the analysis are shown in the form of a ranking using a diagram. The help desk is able to respond to a question as to which configuration change is most readily affected.

The present invention does not use a knowledge database described by humans at all. Even when a user knows the root cause, the user may not know how to easily fix this root cause, and so the present invention does not seek to discover the root cause. Instead, the present invention identifies a tolerance limit. What the user has to do is remove this tolerance limit. For the user, fixing the problem is more effective than notifying the user as to the root cause.

An aspect of the present invention is oriented toward a cause analysis method for a target computer from among multiple computers, and in this method, the target computer is experiencing an application invocation failure of a computer application at a first failure time, and an application invocation success of the computer application at a first success time that precedes the first failure time without being accompanied by another application invocation success, and, in addition, without being accompanied by another application invocation failure of the computer application during a first time period between the first success time and the first failure time (for example, refer to FIG. 14). This method comprises (1) a step of identifying either one or multiple first configuration changes that have occurred during the first time period of the computer application, and (2) a step of executing at least one of either a causal configuration changes analysis (A) or a fixing configuration changes analysis (B). The analysis (A) includes, with respect to all of the other computers of these multiple computers with the exception of the target computer, the acquisition of all of the above-mentioned other computers experiencing an application invocation success of the same computer application at a second success time, and an application invocation failure of the same computer application at a second failure time that is after the second success time without being accompanied by another application invocation success, and, in addition, without being accompanied by another application invocation failure of the same computer application during a second time period between the second success time and the second failure time by identifying an instance of another application invocation failure, identifying either one or multiple second configuration changes that occurred during the second time period, and totaling for all of the multiple computers with the exception of the target computer the number of causal configuration changes of a total of each of the either one or multiple second configuration changes (for example, refer to FIG. 17). The analysis (B) includes, with respect to all of the other computers of these multiple computers with the exception of the target computer, the acquisition of all of the above-mentioned other computers experiencing an application invocation failure of the same computer application at a third failure time, and an application invocation success of the same computer application at a third success time that is after the third failure time without being accompanied by another application invocation success, and, in addition, without being accompanied by another application invocation failure of the same computer application during a third time period between the third failure time and the third success time by identifying an instance of an application invocation success, identifying either one or multiple third configuration changes that occurred during the third time period, and totaling for all of the multiple computers with the exception of the target computer the number of fixed configuration changes of a total of each of the either one or multiple third configuration changes (for example, refer to FIG. 19).

Another aspect of the present invention is oriented toward a cause analysis system, and this system comprises multiple computers comprising a target computer and an analysis computer that is coupled to these multiple computers. The analysis computer is programmed to execute the above-mentioned steps (1) and (2). In a number of the embodiments, the analysis computer becomes one of the above-mentioned multiple computers (For example, refer to FIG. 25).

Another aspect of the present invention is oriented toward a computer-readable storage medium that stores multiple instructions for controlling a data processor that executes the above-mentioned steps (1) and (2).

In a number of the embodiments, the method also comprises a step of presenting the result of at least one of either a causal configuration change result (A1) or a fixing configuration change result (B1). In the step (A1), with respect to either one or multiple second configuration changes, the method comprises listing the number of instances of application invocation failures identified for all of the above-mentioned other computers, and all of the instances respectively accompanying either one or multiple second configuration changes for all of the above-mentioned other computers (for example, refer to FIG. 10). In the step (B1), with respect to either one or multiple third configuration changes, the method comprises listing the number of instances of application invocation successes identified for all of the above-mentioned other computers, and all of the instances respectively associated with either one or multiple third configuration changes for all of the above-mentioned other computers (for example, refer to FIG. 12).

In a number of the embodiments, the steps (1) and (2) are executed with respect to multiple computer applications. In addition, the method comprises a step of presenting the result of at least one of either a causal configuration change result (A2) or a fixing configuration change result (B2). In the step (A2), with respect to either one or multiple second configuration changes, the method comprises listing the number of instances of application invocation failures identified for all of the above-mentioned other computers, and all of the instances respectively associated with either one or multiple second configuration changes for all of the above-mentioned other computers, and listing the date and time at which each of the multiple computer applications was analyzed (for example, refer to FIG. 21). In the step (B2), with respect to either one or multiple third configuration changes, the method comprises listing the number of instances of application invocation successes identified for all of the above-mentioned other computers, and all of the instances respectively associated with either one or multiple third configuration changes for all of the above-mentioned other computers, and listing the date and time at which each of the multiple computer applications was analyzed.

The method in a specific embodiment further comprises a step of executing at least one of either a matching causal configuration changes analysis (A3) or a matching fixing configuration changes analysis (B3) with respect to a specified computer application. In the step (A3), the method comprises searching for the result of (A2) with respect to a computer application that is consistent with the specified computer application as a matching causal configuration change result, and fetching this matching causal configuration change result for analysis (for example, refer to FIG. 22). In the step (B3), the method comprises searching for the result of (B2) with respect to a computer application that is consistent with the specified computer application as a matching fixing configuration change result, and fetching this matching fixing configuration change result for analysis.

The method in a number of the embodiments further comprises a step of executing at least one of either a combined causal configuration changes analysis (C) or a combined fixing configuration changes analysis (D). In the step (C), with respect to all of the other computers besides the target computer of the multiple computers, the method comprises acquiring all of the above-mentioned other computers experiencing an application invocation success of the same computer application at a fourth success time, and an application invocation failure of the same computer application at a fourth failure time that is after the fourth success time without being accompanied by another application invocation success, and, in addition, without being accompanied by another application invocation failure of the same computer application during a fourth time period between the fourth success time and the fourth failure time by identifying an instance of another application invocation failure, identifying either one or multiple combinations of a fourth configuration change that occurred during the fourth time period, and totaling for all of the multiple computers with the exception of the target computer the number of causal configuration changes of a total of each of the combinations of the fourth configuration change (for example, refer to FIG. 24). The analysis (D) includes, with respect to all of the other computers of these multiple computers with the exception of the target computer, the acquisition of all of the above-mentioned other computers experiencing an application invocation failure of the same computer application at a fifth failure time, and an application invocation success of the same computer application at a fifth success time that is after the fifth failure time without being accompanied by another application invocation success, and, in addition, without being accompanied by another application invocation failure of the same computer application during a fifth time period between the fifth failure time and the fifth success time by identifying an instance of an application invocation success, identifying either one or multiple combinations of fifth configuration changes that occurred during the fifth time period, and totaling for all of the multiple computers with the exception of the target computer the number of fixing configuration changes of a total of each of the either one or multiple fifth configuration changes.

In a number of the embodiments, the method comprises a step of presenting the result for at least one of the combined causal configuration change result (C1) or the combined fixing configuration change result (D1). In the step (C1), with respect to either one or multiple combinations of a fourth configuration change, the method comprises listing the number of instances of application invocation failures identified for all of the above-mentioned other computers, and all of the instances respectively accompanying either one or multiple combinations of the fourth configuration changes for all of the above-mentioned other computers. In the step (D1), with respect to either one or multiple combinations of a fifth configuration change, the method comprises listing the number of instances of application invocation successes identified for all of the above-mentioned other computers, and all of the instances respectively accompanying either one or multiple combinations of the fifth configuration changes for all of the above-mentioned other computers.

Another aspect of the present invention is oriented toward a method in a computer system for executing a cause analysis for a target computer from among multiple computers, and in this method, the target computer is experiencing an application invocation failure of a computer application at a first failure time, and an application invocation success of the computer application at a first success time that precedes the first failure time without being accompanied by another application invocation success, and, in addition, without being accompanied by another application invocation failure of the computer application during a first time period between the first success time and the first failure time. This method comprises a step of presenting a causal configuration changes table that lists either one or multiple first configuration changes, which occurred during the first time period of the computer application, and a graphical chart, which corresponds to each of the first configuration changes of this one or multiple first configuration changes, and which comprises a failure rate area and a success rate area. The failure rate area represents a failure case that identifies an instance of another application invocation failure in which, with respect to all of the other computers with the exception of the target computer of these multiple computers, all of the above-mentioned other computers experience an application invocation success of the same computer application at a second success time, and an application invocation failure of the same computer application at a second failure time that is after the second success time without being accompanied by another application invocation success, and, in addition, without being accompanied by another application invocation failure of the same computer application during a second time period between the second success time and the second failure time. A second configuration change that is equivalent to a corresponding first configuration change listed in the table occurs during the second time period. The success rate area represents a success case that identifies an instance other than another application invocation failure in which, with respect to all of the other computers with the exception of the target computer of the multiple computers, all of the above-mentioned other computers experience an application invocation success of the same computer application at a third success time, and an application invocation failure of the same computer application at a third failure time that is after the third success time without being accompanied by another application invocation success, and, in addition, without being accompanied by another application invocation failure of the same computer application during a third time period between the third success time and the third failure time. A third configuration change that is equivalent to a corresponding first configuration change listed in the table occurs during the third time period.

In a number of the embodiments, the above-mentioned graphical chart comprises a bar graph, the failure rate area shows at least one of either a number of failure cases or a percentage of the failure cases when the total number of both failure cases and success cases has been compared, and the failure success area shows at least one of either a number of success cases or a percentage of the success cases when the total number of both failure cases and success cases has been compared. The causal configuration changes table lists the configuration item(s) and change type(s) of either one or multiple first configuration changes, a change date time corresponding to either one or multiple first configuration changes, and a graphical chart showing the failure rate area and the success rate area. In addition, this method comprises a step of presenting the user with a sort key index for sorting the causal configuration changes table in accordance with any one of the configuration item, the change type, the change date time and the graphical chart, and a step of presenting, in response to the sort key index selection inputted by the user, the causal configuration changes table that has been sorted in accordance with the selection inputted by the user.

These and other characteristic features and advantages of the present invention should be clear to a person having ordinary skill in the art by studying the following detailed descriptions of the specific embodiments.

### BRIEF DESCRIPTION OF DRAWINGS

FIG. 1 is a block diagram illustrating an example of the hardware configuration for a client-server architecture to which the application of the method and apparatus of the present invention is conceivable.

FIG. 2 is a block diagram illustrating an example of the functional blocks of the present invention that are to be applied to the architecture of FIG. 1.

FIG. 3 is a schematic diagram showing an example of the relationship between an application invocation result and a configuration change that illustrates the basic concept of the present invention.

FIG. 4 is a schematic diagram showing an example of a user interface of a cause analysis program.

FIG. 5 is a schematic diagram showing an example of a result screen of the cause analysis program.

FIG. 6 is a schematic diagram showing an example of an event log table that resides in an analysis computer.

FIG. 7 is a schematic diagram showing an example of causal change history table that resides inside the analysis computer.

FIG. 8 is a schematic diagram showing an example of an application invocation history table that resides inside the analysis computer.

FIG. 9 is a schematic diagram showing an example of a causal configuration changes temporary table that resides inside the analysis computer in accordance with a first embodiment of the present invention.

FIG. 10 is a schematic diagram showing an example of a causal configuration changes table that resides inside the analysis computer.

FIG. 11 is a schematic diagram showing an example of a fixing configuration changes temporary table that resides inside the analysis computer.

FIG. 12 is a schematic diagram showing an example of a fixing configuration changes table that resides inside the analysis computer.

FIG. 13 is a flowchart describing an example of a log collection executed by a log collection program residing inside the analysis computer.

FIG. 14 is a flowchart describing an example of a cause analysis executed by a cause analysis program residing inside the analysis computer in accordance with the first embodiment of the present invention.

FIG. 15 is a flowchart describing an example of a target period detection process executed by a target period detector residing inside the analysis computer.

FIG. 16 is a flowchart describing an example of a process for checking an application invocation result that is executed by an invocation result checker residing inside the analysis computer.

FIG. 17 is a flowchart describing an example of a causal configuration changes analysis process that is executed by a causal configuration changes analyzer residing inside the analysis computer in accordance with the first embodiment of the present invention.

FIG. 18 is a flowchart describing an example of a subroutine of the causal configuration changes analysis process of FIG. 17.

FIG. 19 is a flowchart describing an example of a fixing configuration changes analysis process that is executed by a fixing configuration changes analyzer residing inside the analysis computer.

FIG. 20 is a flowchart describing an example of a subroutine of the fixing configuration changes analysis process of FIG. 19.

FIG. 21 is a schematic diagram showing an example of a causal configuration changes table according to a second embodiment of the present invention.

FIG. 22 is a flowchart describing an example of a cause analysis that is executed by a cause analysis program according to the second embodiment of the present invention.

FIG. 23 is a schematic diagram showing an example of a causal configuration changes table according to a third embodiment of the present invention.

FIG. 24 is a flowchart describing an example of a causal configuration changes analysis process that is executed by a causal configuration changes analyzer according to the third embodiment of the present invention.

FIG. 25 is a schematic diagram illustrating an example of the hardware architecture configuration, software modules and tables of the entire system according to a fourth embodiment of the present invention.

FIG. 26 is a block diagram illustrating examples of the functional blocks of an analysis computer and an agent inside a target computer in a fifth embodiment.

FIG. 27 is a flowchart illustrating an example of collection program processing in the fifth embodiment.

FIG. 28 is a schematic diagram showing an example of a user interface that provides agent trouble information in the fifth embodiment.

FIG. 29 is a schematic diagram showing an example of a user interface that provides agent solution information in the fifth embodiment.

FIG. 30 is a schematic diagram showing another example of a user interface that provides agent trouble information in the fifth embodiment.

FIG. 31 is a flowchart describing an example of collection program processing in a sixth embodiment.

FIG. 32 is a flowchart describing an example of cause analysis program processing in the sixth embodiment.

### DESCRIPTION OF EMBODIMENTS

In the detailed explanation of the present invention that follows, reference will be made to the attached drawings which constitute a portion of the disclosure, and which show examples of embodiments as exemplary means for carrying out the present invention without limiting same. In the drawings, similar numbers describe substantially similar components in a number of diagrams. It should also be noted that these detailed explanations provide various examples of embodiments, which are described hereinbelow, and, in addition, are illustrated in the drawings, but the present invention is not limited to the embodiments that are described and illustrated herein, and as a person having ordinary skill in the art knows or will come to know, the present invention can be expanded to include other embodiments. When reference is made to “one embodiment”, “this embodiment”, or “these embodiments” in this specification, this signifies that the specific feature, structure or characteristic described in relation to an embodiment is included in at least one embodiment of the present invention, and the appearance of these phrases at various locations in this specification does not necessarily refer to the same embodiment. In addition, in the following detailed explanation, numerous specific details are given to provide a thorough understanding of the present invention. However, as should be clear to a person having ordinary skill in the art, not all of these specific details are required to carry out the present invention. Under other conditions, known structures, materials, circuits, processes, and interfaces are not explained in detail and/or are illustrated in block diagram format so as to avoid making the present invention unnecessarily obscure.

In addition, a number of parts of the following detailed explanation are provided in the form of an algorithm and reference signs operated on inside a computer. These algorithm definitions and reference signs are means used by a person having ordinary skill in the art in the field of data processing to more effectively communicate the essence of their innovation to other persons having ordinary skill in the art. The algorithm is a series of defined steps that lead to a desired end state or result. In the present invention, an executed step requires physical operation on a perceivable amount in order to achieve a perceivable result. Usually, but not always, these amounts take the form of either an electrical or magnetic signal or instruction with respect to which storing, transferring, bonding, comparing or another such operation is possible. Referring to these signals as bits, values, elements, signs, letters, items, numbers, instructions or the like often proves advantageous. However, it must be kept in mind that all of these and other similar terms are related to appropriate physical amounts, and are merely convenient labels applied to these amounts. Unless otherwise noted, as will be clear from the following considerations, it is recognized that the use of “process”, “computing”, “compute”, “determine”, “display” or other such terminology throughout his explanation may include the operation and processing of a computer system or other such information processing device, which operates on data that is expressed as a physical (electronic) amount inside the registers and memory of a computer system and converts this data to other data that is similarly expressed as a physical amount inside either the memory or registers of the computer system, or another information storage, transmission, or display device.

The present invention also relates to an apparatus for executing an operation thereinside. This apparatus is either specially designed for a desired purpose, or may include one or multiple general-purpose computers, which are either selectively booted or reconfigured by either one or multiple computer programs. This type of computer program may be stored inside a computer-readable storage medium, such as but not limited to an optical disk, a magnetic disk, a read-only memory, a random access memory, a solid state device and drive, or any other type of medium that is suitable for storing electronic information. An algorithm and display provided here are not inherently related to any specific computer or other apparatus. It can also be proven that either various general-purpose systems may be used together with programs and modules in accordance with the teachings included herein, or that there are advantages to configuring a more specialized apparatus to execute the steps of a desired method. In addition, the present invention will not be described by referring to any specific programming language. It should be recognized that the teachings of the present invention can be implemented as described herein using a variety of programming languages. A programming language (one or multiple) instruction(s) may be executed by one or multiple processing devices, for example, a central processing unit (CPU), a processor, or a controller.

An exemplary embodiment of the present invention, as will be explained in more detail hereinbelow, provides an apparatus, a method, and a computer program for finding a solution to an application failure by analyzing a configuration change without using a knowledge database.

### A. First Embodiment

### 1. System Configuration

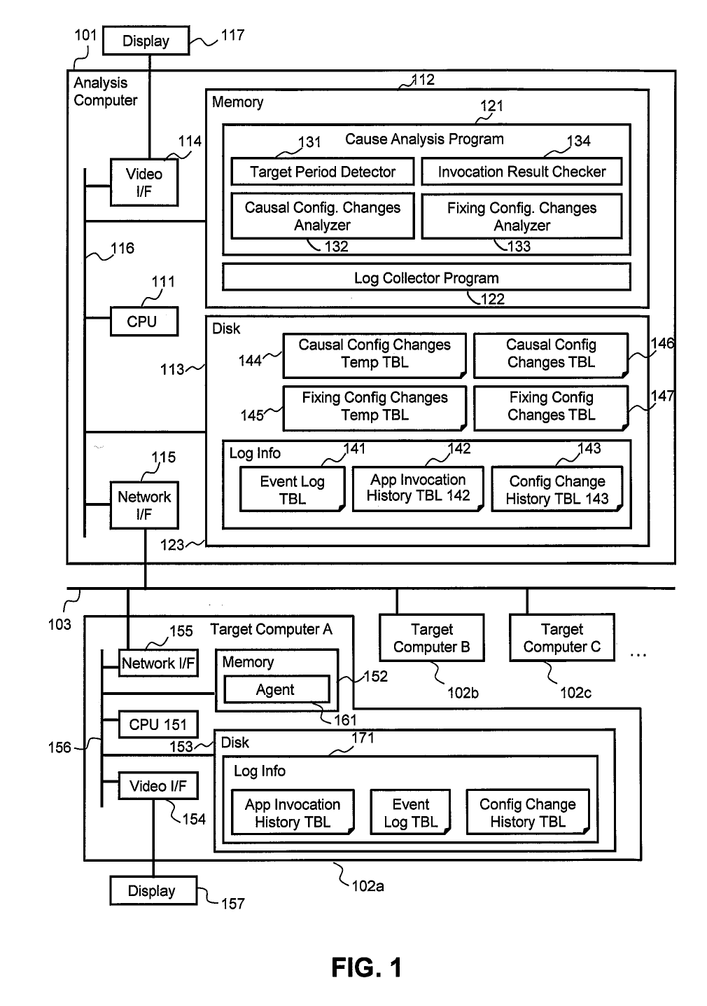

FIG. 1 illustrates an example of a hardware configuration for a client-server architecture for which the method and apparatus of the present invention is considered applicable. An analysis computer 101 and multiple target computers 102 are coupled by way of a LAN 103. The analysis computer 101 is a general-purpose computer comprising a CPU 111, a memory 112, a disk 113, a video interface 114 and a network interface 115. The respective elements are coupled via a system bus 116. The analysis computer 101 comprises a cause analysis program 121 and a log collector program 122 inside the memory 112. The cause analysis program 121 comprises a target period detector 131, a causal configuration changes analyzer 132, a fixing configuration changes analyzer 133, and an invocation result checker 134 executed by the CPU 111. The analysis computer 101 comprises a causal configuration changes temporary table 144, a fixing configuration changes temporary table 145, a causal configuration changes table 146, a fixing configuration changes table 147, and log information 123 inside the disk 113. The log information 123 comprises an event log table 141, an application invocation history table 142, and a configuration change history table 143. The analysis computer 101 comprises a network interface 115, which is used to collect log information 171 from the multiple target computers 102 coupled to the LAN 103. A display 117 is coupled to the video interface 114 and is used to display the result of a causal configuration changes analysis by the cause analysis program. 121 and the user interface of the cause analysis program 121.

The target computer 102 is a general-purpose computer comprising a CPU 151, a memory 152, a disk 153, a video interface 154, and a network interface 155. The respective elements are coupled by way of a system bus 156. The target computer 102 comprises an agent 161 for sending the log information 171 to the analysis computer 101 via the LAN 103. The target computer 102 comprises the log information 171 inside the disk 153. A display 157 is coupled to the video interface 154.

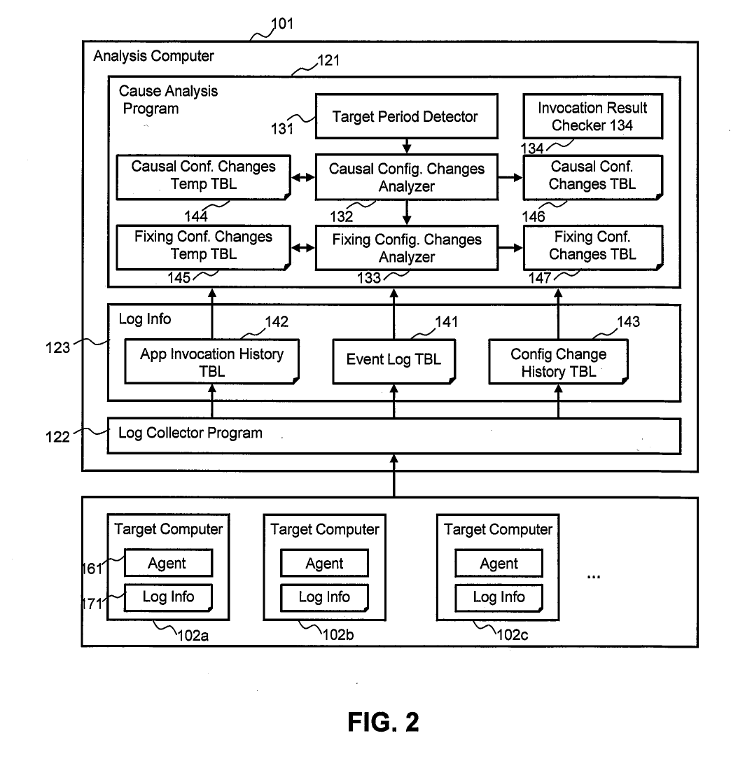

FIG. 2 illustrates an example of a functional block diagram of the present invention that is applied to the architecture of FIG. 1. The log collector program 122 resides in the analysis computer 101, collects the log information 171 by communicating with the respective agents 161 that reside in the target computers 102, and stores this information in the event log table 141, the application invocation history table 142, and the configuration change history table 143 of the log information 123 in the analysis computer 101.

The cause analysis program 121 reads the log information 123 and executes a causal configuration changes analysis as described hereinbelow. The target period detector 131 reads the event log table 141, the application invocation history table 142, and the configuration change history table 143, and detects the time period between the point in time at which a specific application was able to be invoked without trouble, and the point in time at which this application was not able to be invoked without trouble (=failed). Thereafter, the target period detector 131 determines the configuration change in the target computer during this time period by referencing the configuration change history table 143. The causal configuration changes analyzer 132 checks the log information 123 of the other computer(s) and stores the result(s) in the causal configuration changes table 146. The causal configuration changes temporary table 144 is used as temporary data when the causal configuration changes analyzer 132 is analyzing the causal configuration change.

The fixing configuration changes analyzer 133 detects a fixing configuration change and stores the result in the fixing configuration changes table 147. The fixing configuration changes temporary table 145 is used as temporary data when the fixing configuration changes analyzer 133 is analyzing the fixing configuration change. The fixing configuration change is a configuration change for fixing a state in which there is an application invocation failure or other such trouble. The invocation result checker 134 is a subroutine that detects whether or not a specific application was able to be invoked without trouble by referencing both the event log table 141 and the application invocation history table 142.

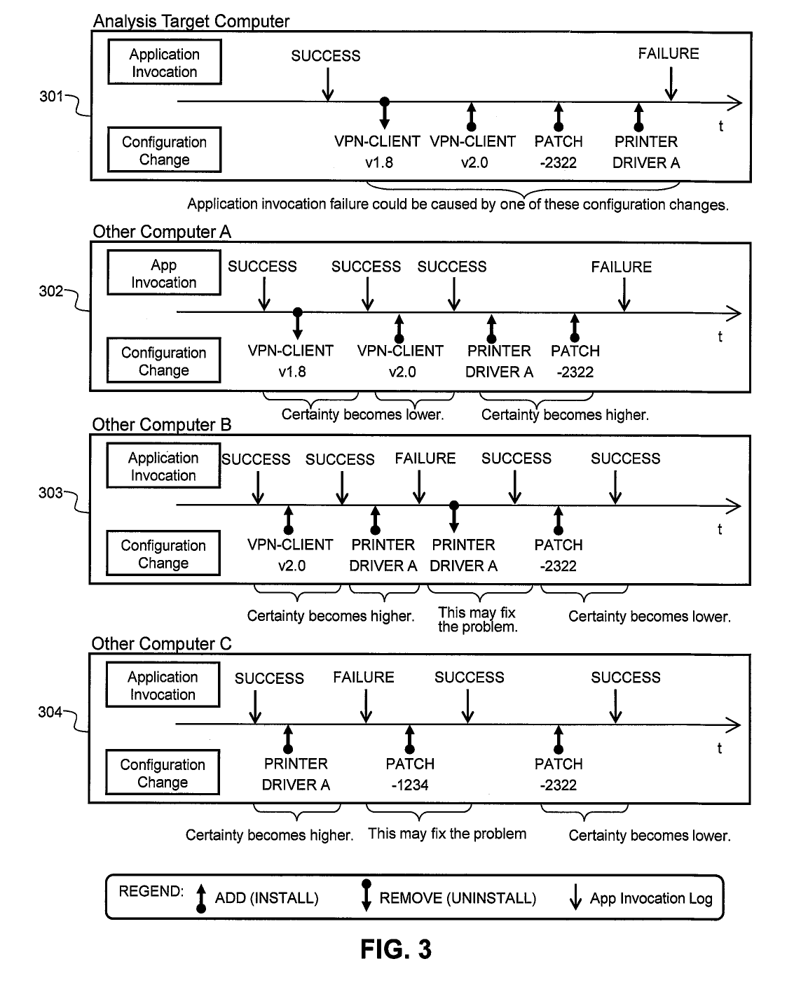

FIG. 3 shows examples 301 through 304 of the relationship between an application invocation result and a configuration change that illustrates the basic concept of the present invention.

Schematic 301 shows the state of the target computer 102 of this causal configuration changes analysis. According to the schematic 301, four configuration changes occurred between a successful invocation and a failed invocation of the application. There is no other invocation between these configuration changes. Therefore, the application invocation failure could have been caused by one of these four configuration changes. Schematics 302, 303, and 304 show the states of the other computers, and these states will be used for detailed analysis.

According to schematic 302, the same configuration changes occurred in the other computer A, but neither the removal of “VPN-CLIENT v1.8” nor the addition of “VPN-CLIENT v2.0” affected the invocation of this application. Therefore, the certainty with respect to these two configuration changes having affected the invocation of this application becomes lower. By contrast, the addition of the “PRINTER DRIVER A” and the “PATCH-2322” produced results between a success and a failure. Therefore, the certainty with respect to these two configuration changes having affected the invocation of this application becomes higher.

According to schematic 303, the addition of the “PRINTER DRIVER A” produced a result between a success and a failure. Therefore, the certainty with respect to this configuration change having affected the invocation of this application becomes higher. In addition, the removal of the “PRINTER DRIVER A” subsequent to the failure produced a result between a failure and a success. Therefore, the removal of the “PRINTER DRIVER A” is seen as having fixed the problem. The certainty with respect to this configuration change having fixed the application invocation becomes higher. In addition to this, since the addition of the “PATCH-2322” produced a result between a success and a success, the certainty with respect to this configuration change having affected the application invocation becomes lower.

According to schematic 304, the addition of a “PATCH-1234” comes between a failure and a success, and therefore the addition of the “PATCH-1234” is seen as having fixed the problem. This type of observation can lead to two types of results. The one is the certainty with respect to which configuration factor affected the invocation of the application. The other is the certainty with respect to which configuration change was able to fix the application invocation trouble (the failure). There are three other computers in this example, and the accuracy of the analysis could be increased further by adding the other computers.

### 2. Analysis Program User Interface

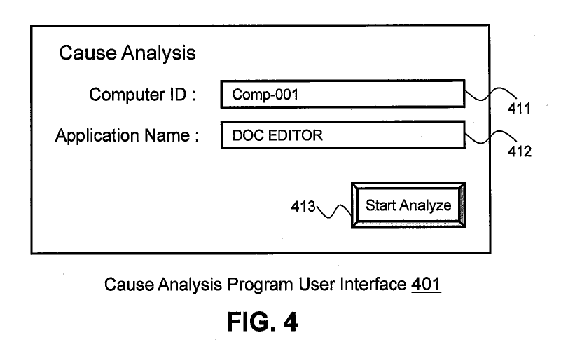

FIG. 4 shows an example of a user interface 401 of the cause analysis program 121. The user is able to start an analysis by using this user interface 401. The cause analysis program user interface 401 comprises two text boxes for inputting analysis conditions. The one is a computer ID 411, and the user is able to use this text box to specify the identifier of the analysis target computer. The other is an application name 412, and the user is able to use this text box to specify the name of the application that is having trouble. The user can start the analysis by pressing a “Start analysis” button 413.

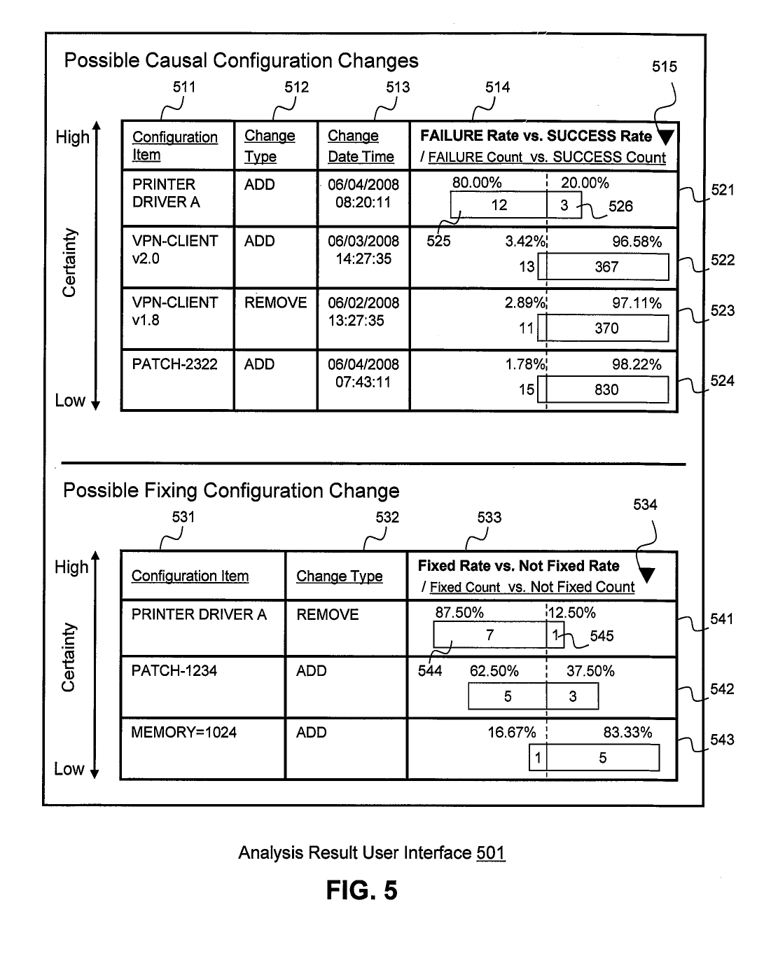

FIG. 5 shows an example of a result screen of the cause analysis program 121. Potential causal configuration changes are displayed in the form of a ranking inside the top pane. A column 511 shows a configuration item. A column 512 shows a change type. A column 513 shows a date and a time that correspond to a configuration change (that is, 511 and 512). FIG. 5 shows four configuration change records 521 through 524. A column 514 shows bar graphs denoting the certainty corresponding to the configuration changes. A field 525 shows the number of cases of configuration changes (“PRINTER DRIVER A”-“Added”) in the record 521 that affected the invocation of applications specified in all the computers. A field 526 shows the number of cases of configuration changes (“PRINTER DRIVER A”-“Added”) that did not affect the invocation of applications specified in all the computers. The percentages in the bar graphs show the ratios of 515 to 526. A sign 515 is a sort key indicator. In this example, these configuration changes are shown in rate (certainty) order rather than numerically. This indicator can be moved to another column by clicking on the link (underline) in the respective columns.

Potential fixing configuration changes are displayed in the form of a ranking in the bottom pane. A column 532 shows the configuration item. A column 532 shows the change type. A column 533 shows bar graphs denoting the certainty corresponding to the configuration changes. FIG. 5 shows three configuration change records 541 through 543. A field 544 shows the number of cases of configuration changes (“PRINTER DRIVER A”-“Removed”) in the record 541 that fixed the invocation failure of the applications specified in all the computers. A field 545 shows the number of cases of configuration changes (“PRINTER DRIVER A”-“Removed”) that did not fix the invocation failure of the applications specified in all the computers. The percentages in the bar graphs show the ratios of 544 to 545. A sign 534 is the sort key indicator. In this example, these configuration changes are shown in rate (certainty) order rather than numerically.

### 3. Data Structure

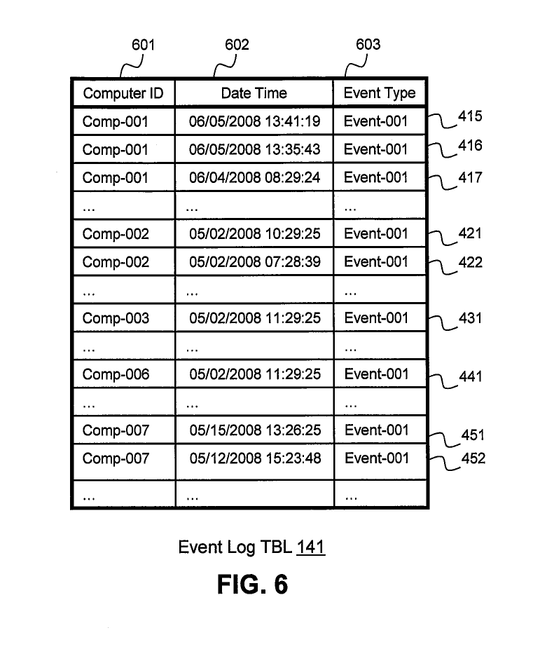

FIG. 6 shows an example of an event log table 141 that resides in the analysis computer 101. The event log data in this table is used to determine whether or not a specified application can be invoked without trouble. The invocation result checker 134 checks the number of events immediately subsequent to an application invocation. In a case where a number of events are discovered within a specific period immediately subsequent to the invocation, the invocation result checker 134 determines that this application invocation failed.

The event log table 141 comprises three columns, i.e., a computer ID (601), a date time (602) and an event type (603). The computer ID 601, the date time 602, and the event type 603 are collected from the agents 161 of the respective target computers 102 by the log collector program 122, and stored in this table. A table summary of the event log table in each target computer 102 is the same as that of the event log table 141 of the analysis computer 101 in this embodiment. FIG. 6 shows event log records 415 through 417 for a Comp-001, records 421 and 422 for a Comp-002, record 431 for a Comp-003, record 441 for a Comp-006, records 451 and 452 for a Comp-007 and so on. The event log table in each target computer 102 comprises its own event log data. The event log table 141 in the analysis computer 101 comprises all of the event log data collected from the respective target computers 102.

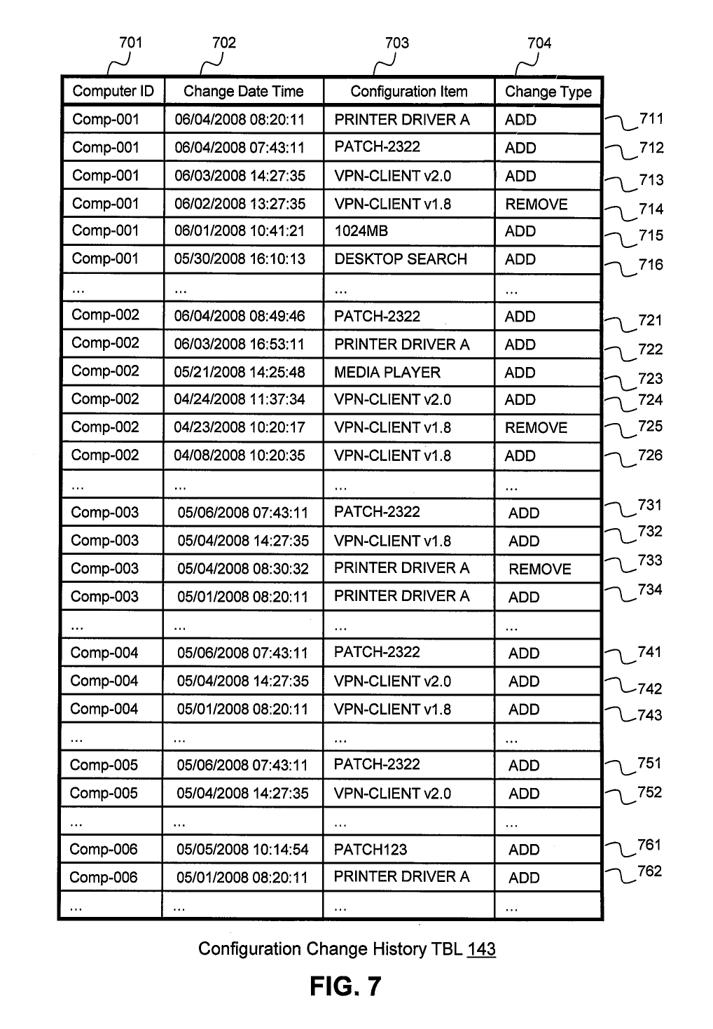

FIG. 7 shows an example of the configuration change history table 143 that resides in the analysis computer 101. The configuration change history data in this table is used to determine what type of configuration changes took place between a successful application invocation and a failed invocation, and what type of configuration change fixed a failed application invocation.

The configuration change history table 143 comprises four columns, i.e., a computer ID 701, a change date time 702, a configuration item. 703 and a change type 704. The data of these four columns is collected from the agents 161 of the respective target computers 102 by the log collector program 122 and stored in this table. A table summary of the configuration change history table of each target computer 102 is the same as that of the configuration change history table 143 of the analysis computer 101 in this embodiment. The configuration change history table in each target computer 102 comprises its own configuration change history data. The configuration change history table 143 in the analysis computer 101 comprises all of the configuration change history data collected from the respective target computers 102.

Examples of configuration items include software, an application (add/remove), a patch (add/remove), a driver (add/remove), an OS configuration, processor scheduling (program/background service), memory usage (program/system cache), optional registry items, hardware, memory capacity, hard drive capacity, BIOS configuration, hyper-thread (ON/OFF), and virtualization technology (ON/OFF). FIG. 7 shows configuration change history records 711 through 716 for the Comp-001, records 721 through 726 for the Comp-002, records 731 through 734 for the Comp-003, records 741 through 743 for the Comp-004, records 751 and 752 for a Comp-005, records 761 and 762 for the Comp-006, and so on.

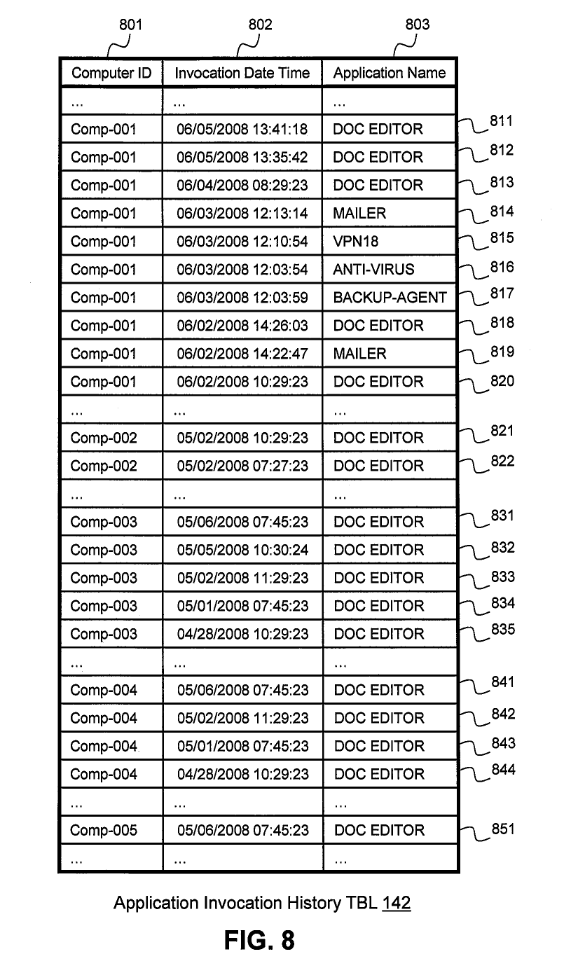

FIG. 8 shows an example of the application invocation history table 142 that resides in the analysis computer 101. The application invocation history data in this table is used to determine when applications were invoked before and after a configuration change. This table comprises three columns, i.e., a computer ID 801, an invocation date time 802, and an application name 803. The data of these three columns is collected from the agents 161 of the respective target computers 102 by the log collector program 122 and stored in this table. A table summary of the application invocation history table of each target computer 102 is the same as that of the application invocation history table 142 of the analysis computer 101 in this embodiment. The application invocation history table in each target computer 102 comprises its own application invocation history data. The application invocation history table 142 in the analysis computer 101 comprises all of the application invocation history data collected from the respective target computers 102. FIG. 8 shows application invocation history records 811 through 820 for the Comp-001, records 821 and 822 for the Comp-002, records 831 through 835 for the Comp-003, records 841 through 844 for the Comp-004, record 851 for the Comp-005, and so on.

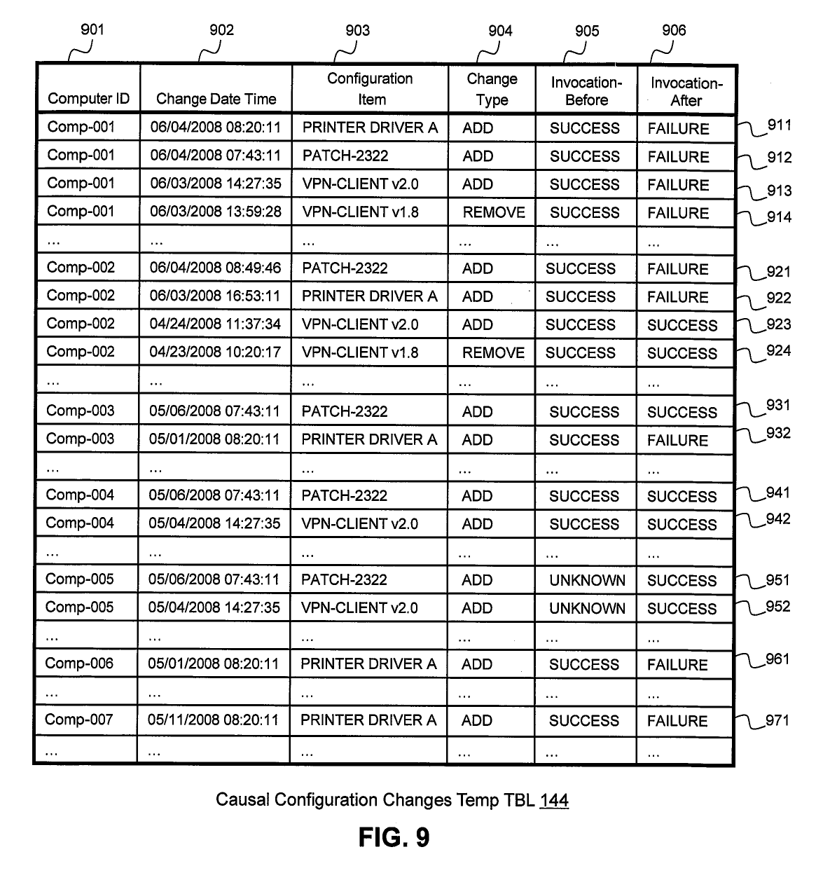

FIG. 9 shows an example of the causal configuration changes temporary table 144 in the analysis computer 101 in accordance with the first embodiment of the present invention. This table is a temporary table for when the cause analysis program 121 determines a causal configuration change. This table shows the results of an application invocation before and after a configuration change. This table comprises six columns, i.e., a computer ID 901, a change date time 902, a configuration item 903, a change type 904, an invocation-before 905, and an invocation-after 906. The invocation-before 905 shows the result of an application invocation prior to a configuration change. The invocation-after 906 shows the result of an application invocation subsequent to a configuration change.

A record shows the time period from the last successful application invocation to the first failed application invocation for each analysis target computer 102. It is supposed that the value of the computer ID 901 of the analysis target computer 102 in FIG. 9 is “Comp-001”. For example, all of the values for the pairs of invocation-before 905 and invocation-after 906 of the records (911 through 914) are success and failure, respectively. The records for the other computers show the application invocation results before and after a configuration change the same as the analysis target computer 102. For example, the value of the configuration item 903 and change type 904 pair must be one of “PRINTER DRIVER A—Added”, “PATCH-2322—Added”, “VPN-CLIENT v2.0—Added” or “VPN-CLIENT v1.8—Removed”. FIG. 9 shows causal configuration change records 911 through 914 for the Comp-001, records 921 through 924 for the Comp-002, records 931 and 932 for the Comp-003, records 941 and 942 for the Comp-004, records 951 and 952 for the Comp-005, record 961 for the Comp-006, record 971 for the Comp-007, and so on.

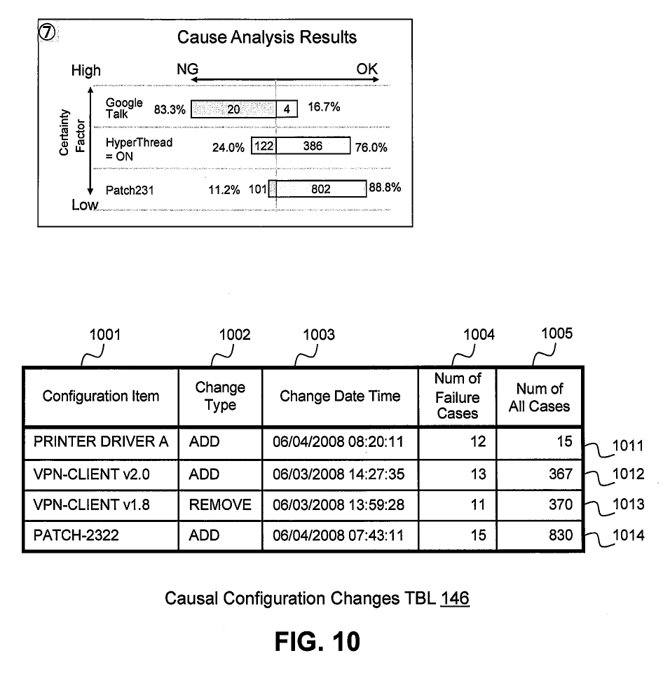

FIG. 10 shows an example of the causal configuration changes table 146 that resides in the analysis computer 101. This table is the table of results created by the cause analysis program 121. This table shows the configuration change that caused an application invocation to fail and the corresponding certainty. This table comprises five columns, i.e., a configuration item 1001, a change type 1002, a change date time 1003, a number of failure cases 1004, and a number of all cases 1005. The number of all cases 1005 shows all the cases for the configuration item 1001 and the change type 1002 pair. The number of failure cases 1004 shows the number of cases of failed invocation for the configuration item 1001 and the change type 1002 pair. FIG. 10 shows four causal configuration change records 1011 through 1014. For example, in the record 1011, the configuration change is “PRINTER DRIVER A—Added”, the number of failure cases 1004 is 12, and the number of all cases 1005 is 15.

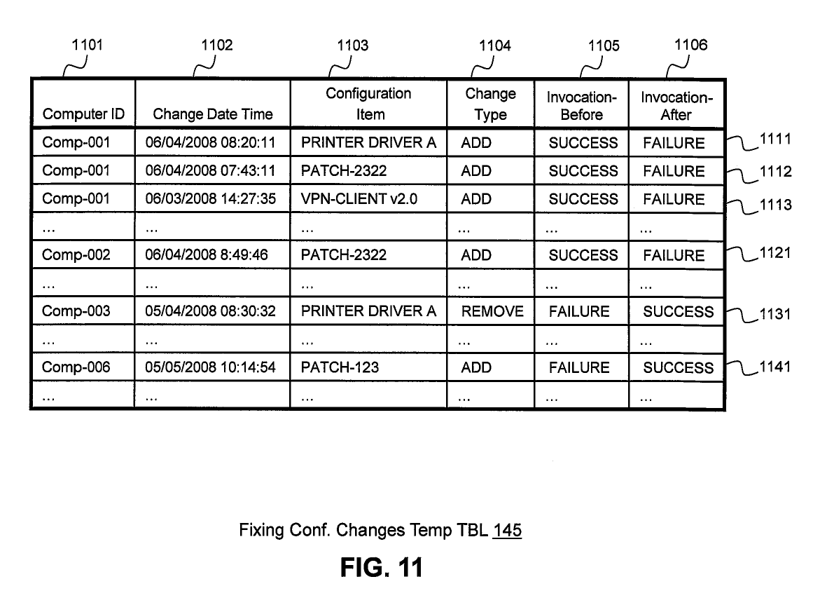

FIG. 11 shows an example of the fixing configuration changes temporary table 145 that resides in the analysis computer 101. This table is a temporary table for when the cause analysis program 121 determines a fixing configuration change. This table shows the results of an application invocation before and after a configuration change that occurred between the invocation failure and the invocation success of a specified application. This table comprises six columns, i.e., a computer ID 1101, a change date time 1102, a configuration item 1103, a change type 1104, an invocation-before 1105, and an invocation-after 1106. The meanings of the respective columns are the same as those of the causal configuration changes temporary table 144. FIG. 11 shows fixing configuration change records 1111 through 1113 for the Comp-001, record 1121 for the Comp-002, record 1131 for the Comp-003, record 1141 for the Comp-004, and so on.

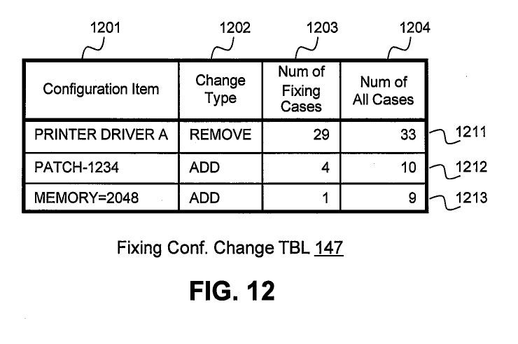

FIG. 12 shows an example of the fixing configuration changes table 147 that resides in the analysis computer 101. This table is the table of results created by the cause analysis program 121. This table shows the configuration change that fixed a failed application invocation and the corresponding certainty. This table comprises four columns, i.e., a configuration item 1201, a change type 1202, a Number of fixing cases 1203, and a number of all cases 1204. The number of all cases 1204 shows all the cases for the configuration item 1201 and the change type 1202 pair. The Number of fixing cases 1203 shows the number of cases of fixing for the configuration item 1201 and the change type 1202 pair. For example, in a record 1211, the configuration change is “PRINTER DRIVER A—Added”, the Number of fixing cases 1203 is 29, and the number of all cases 1204 is 33. FIG. 12 shows fixing configuration change records 1211 through 1213.

### 4. Process Flow

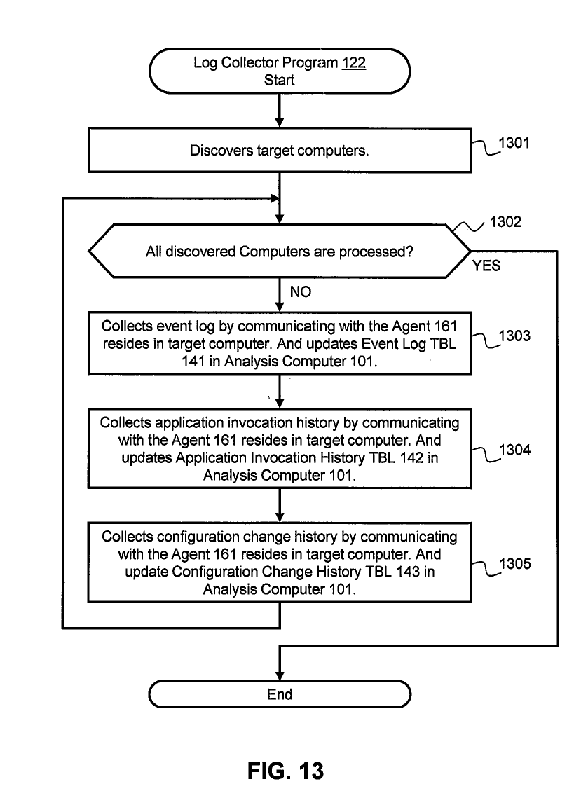

FIG. 13 is an example of a flowchart describing the log collection executed by the log collector program 122 that resides in the analysis computer 101. The log collector program 122 cyclically commences this process at specified intervals. As described in FIG. 13, in Step 1301, the log collector program 122 discovers a target computer for log collection. In Step 1302, the log collector program (122) checks whether or not all the discovered computers have undergone processing. In the case of a YES, the processing ends. In the case of a NO, the processing proceeds to Step 1303. In Step 1303, the log collector program 122 collects the event logs by communicating with the agent 161 residing in the target computer 102. The program 122 also updates the event log table 141 in the analysis computer 101. In Step 1304, the log collector program 122 collects the application invocation history by communicating with the agent 161 residing in the target computer 102. The program 122 also updates the application invocation history table 142 in the analysis computer 101. In Step 1305, the log collector program 122 collects the configuration change history by communicating with the agent 161 residing in the target computer 102. The program 122 also updates the configuration change history table 143 in the analysis computer 101. Upon processing the log information of all the discovered computers (the check performed in Step 1302), the log collector program 122 ends the processing.

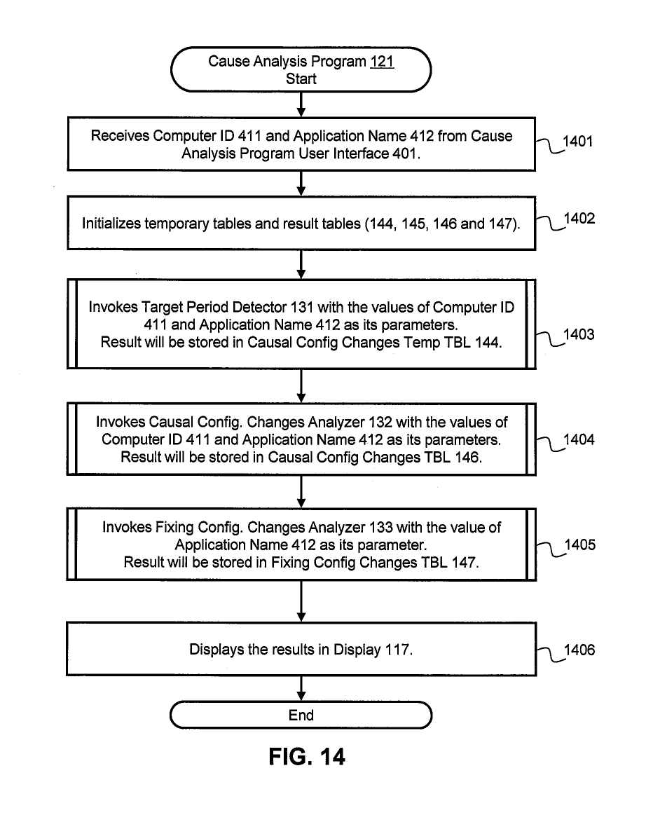

FIG. 14 is an example of a flowchart describing a cause analysis executed by the cause analysis program 121 that resides in the analysis computer 101 in accordance with the first embodiment of the present invention. The cause analysis program 121 commences processing by a user operation on the cause analysis program user interface 401. As described in FIG. 14, in Step 1401, the cause analysis program. 121 receives a computer ID 411 and an application name 412 as parameters from the cause analysis program user interface 401. In this explanation, the computer ID is “Comp-001” and the application name is “DOC EDITOR”. In Step 1402, the cause analysis program 121 initializes the temporary tables and the result tables (144, 145, 146 and 147).

In Step 1403, the cause analysis program 121 treats the values of the computer ID 411 and the application name 412 as parameters, and calls the target period detector 131. The result is stored in the causal configuration changes temporary table 144. The records (911 through 914) are stored in the configuration changes temporary table 144 at the time of this step. Therefore, the configuration change that caused the application invocation to fail is deemed to be one of these configuration changes (911 through 914).

In Step 1404, the cause analysis program 121 treats the values of the computer ID 411 and the application name 412 as parameters, and calls the causal configuration changes analyzer 132. The result is stored in the causal configuration changes table 146. The records (1011 through 1014) are stored in the causal configuration changes table 146 at the time of this step.

In Step 1405, the cause analysis program 121 treats the value of the application name 412 as a parameter, and calls the fixing configuration changes analyzer 133. The result is stored in the fixing configuration changes table 147. The records (1211 through 1213) are stored in the fixing configuration changes table 147 at the time of this step. In Step 1406, the cause analysis program 121 displays the results on the display 117.

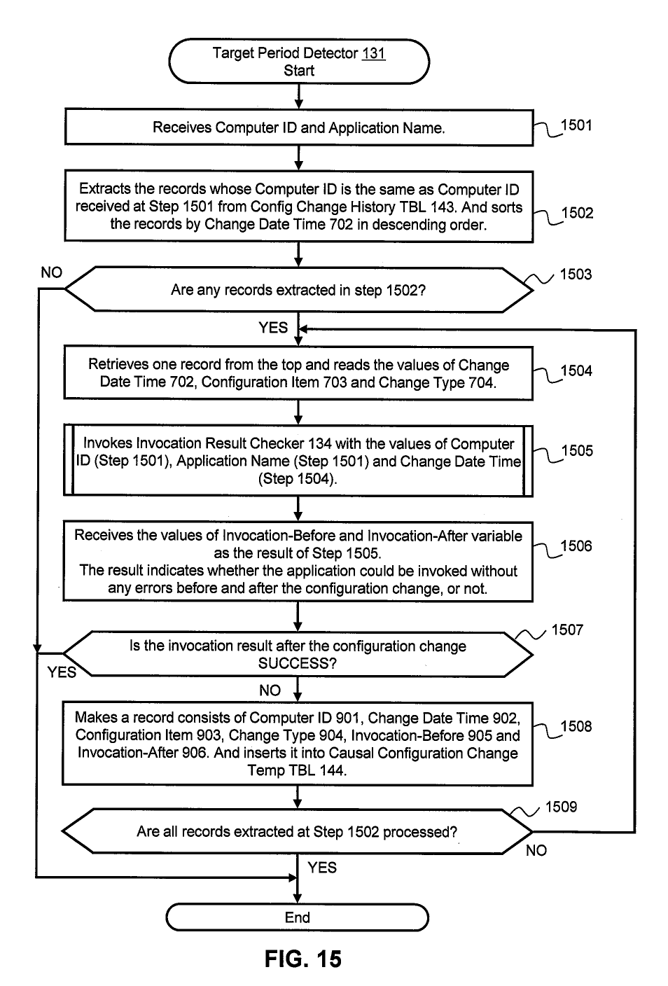

FIG. 15 is an example of a flowchart describing a target time period detection process executed by the target period detector 131 that resides in the analysis computer 101. The target period detector 131 commences processing by being called by the cause analysis program 121. As described in FIG. 15, in Step 1501, the target period detector 131 receives a computer ID and an application name as parameters. In this explanation, the computer ID is “Comp-001” and the application name is “DOC EDITOR”.

In Step 1502, the target period detector 131 selects the records of the same computer ID as the computer ID that was received in Step 1501 from the configuration change history table 143. The detector 131 also sorts the records in descending order in accordance with the change date time 702. The records of the “Comp-001” of the computer ID 701 are selected at the time of this step (711 through 716 in the configuration change history table 143).

In Step 1503, the target period detector 131 checks whether or not the records were selected in Step 1502. In the case of a YES, processing proceeds to Step 1504. In the case of a NO, processing ends.

In Step 1504, the target period detector 131 fetches one record from the top, and reads the values of the change date time 702, the configuration item 703, and the change type 704. At the initial execution of this loop, the value of the change date time 702 is “Jun. 4, 2008 08:20:11”, the configuration item 703 is “PRINTER DRIVER A”, and the change type 704 is “Added”.

In Step 1505, the target period detector 131 treats the computer ID (Step 1501), the application name step (1501) and the change date time (Step 1504) as parameters, and calls the invocation result checker 134. In the initial execution of this loop, these parameters are “Comp-001”, “DOC EDITOR”, and “Jun. 4, 2008 08:20:11”.

In Step 1506, the target period detector 131 receives the values of the Invocation-Before and Invocation-After variables as the results of Step 1505. The results show whether or not the application was able to be invoked before and after the configuration change without any errors. In the initial execution of this loop, the Invocation-Before result value is “success” and the Invocation-After result value is “failure”.

In Step 1507, the target period detector 131 checks whether or not the post-configuration change invocation result is success. In the case of a YES, the processing ends. In the case of a NO, the processing proceeds to Step 1508.

In Step 1508, the target period detector 131 creates a record for the computer ID 901, the change date time 902, the configuration item 903, the change type 904, the invocation-before 905 and the invocation-after 906. The detector 131 also inserts this record in the causal configuration changes temporary table 144. The record 911 is stored in the causal configuration changes temporary table 144 at the time of the initial loop of this step.

In Step 1509, the target period detector 131 checks whether or not all the records selected in Step 1502 have undergone processing. In the case of a YES, the processing ends. In the case of a NO, the processing returns to Step 1504. In this embodiment, the records (911 through 914) are stored in the configuration changes temporary table 144 subsequent to execution of the target period detector 131.

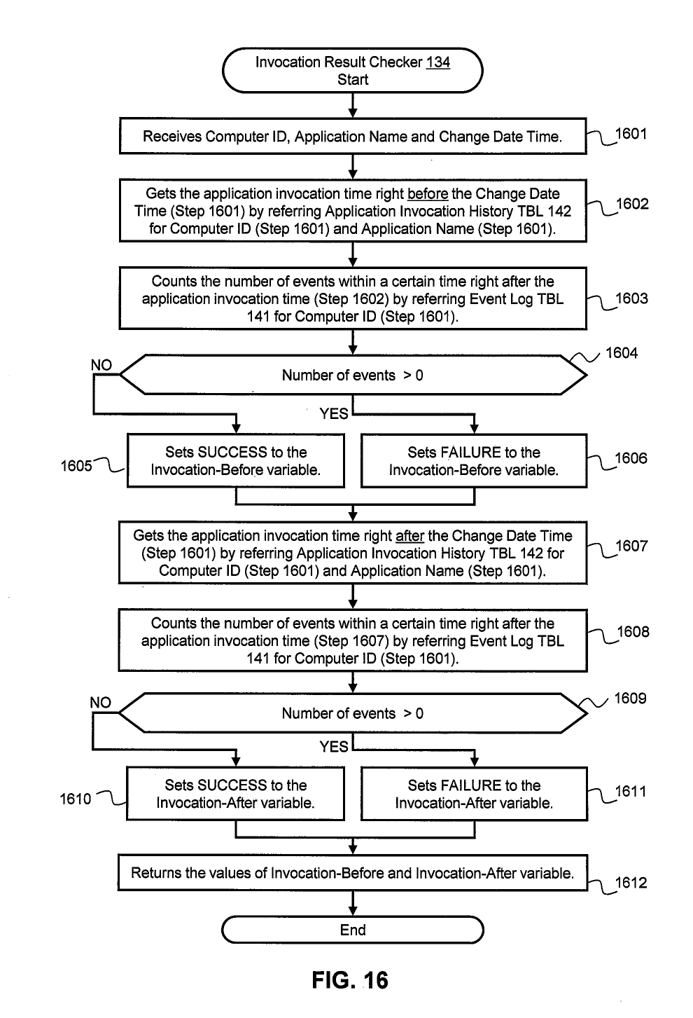

FIG. 16 is an example of a flowchart describing the process for checking the application invocation result executed by the invocation result checker 134 that resides in the analysis computer 101. The invocation result checker 134 commences processing by being called by the target period detector 131, the causal configuration changes analyzer 132 and the fixing configuration changes analyzer 133. As described in FIG. 16, in Step 1601, the invocation result checker 134 receives a computer ID, an application name, and a change date time as parameters. For example, the computer ID is “Comp-001”, the application name is “DOC EDITOR”, and the change date time is “Jun. 4, 2008 08:20:11”.

In Step 1602, the invocation result checker 134 acquires the application invocation time of immediately prior to the change date time (Step 1601) by referencing the application invocation history table 142 with respect to the computer ID (Step 1601) and the application name (Step 1601). When the received change date time is “Jun. 4, 2008 08:20:11”, the “DOC EDITOR” application invocation time immediately prior to “Jun. 4, 2008 08:20:11” can be found as “Jun. 2, 2008 14:26:03” (818) in the application invocation history table 142.

In Step 1603, the invocation result checker 134 counts the number of events within a specified period of time immediately after the application invocation time (Step 1602) by referencing the event log table 141 with respect to the computer ID (Step 1601). When the invocation time is “Jun. 2, 2008 14:26:03”, the number of events within a 10 second period is 0.

In Step 1604, the invocation result checker 134 checks the number of events counted in Step 1603. When this number is larger than 0, the processing jumps to Step 1606. Otherwise, the processing proceeds to Step 1605. In Step 1605, the invocation result checker 134 sets the Invocation-Before variable to success. The Invocation-Before variable is set to success because the number of events is 0. In Step 1606, the invocation result checker 134 sets the Invocation-Before variable to failure.

In Step 1607, the invocation result checker 134 acquires the application invocation time immediately after the change date time (Step 1601) by referencing the application invocation history table 142 with respect to the computer ID (Step 1601) and the application name (Step 1601). When the received change date time is “Jun. 4, 2008 08:20:11”, the “DOC EDITOR” application invocation time immediately after “Jun. 4, 2008 08:20:11” can be found in the application invocation history table 142 as “Jun. 4, 2008 08:29:23” (record 417).

In Step 1608, the invocation result checker 134 counts the number of events within a specified time period immediately after the application invocation time (Step 1607) by referencing the event log table 141 with respect to the computer ID (Step 1601). When the invocation time is “Jun. 4, 2008 08:29:23”, the number of events within a 10-second period is 1.

In Step 1609, the invocation result checker 134 checks the number of events counted in Step 1608. When this number is larger than 0, the processing jumps to Step 1611. Otherwise, the processing proceeds to Step 1610. In Step 1610, the invocation result checker 134 sets the Invocation-After variable to success. In Step 1611, the invocation result checker 134 sets the Invocation-After variable to failure. The Invocation-After variable is set to failure because the number of events is 1.

In Step 1612, the invocation result checker 134 returns the values of the Invocation-Before and Invocation-After variables. In this explanation, the Invocation-Before return value is success, and the Invocation-After value is failure.

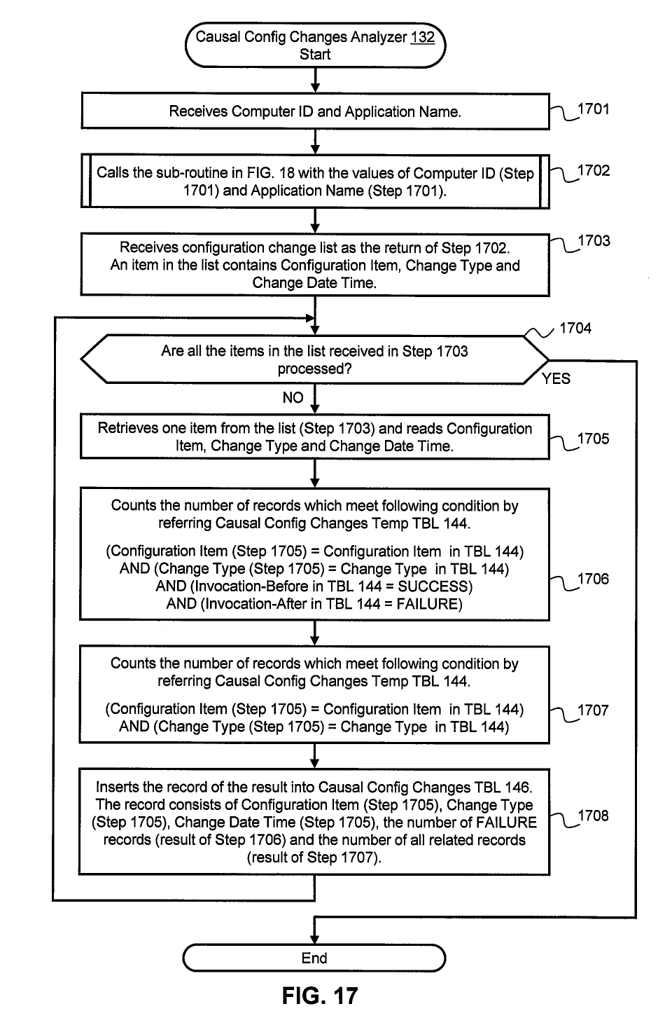

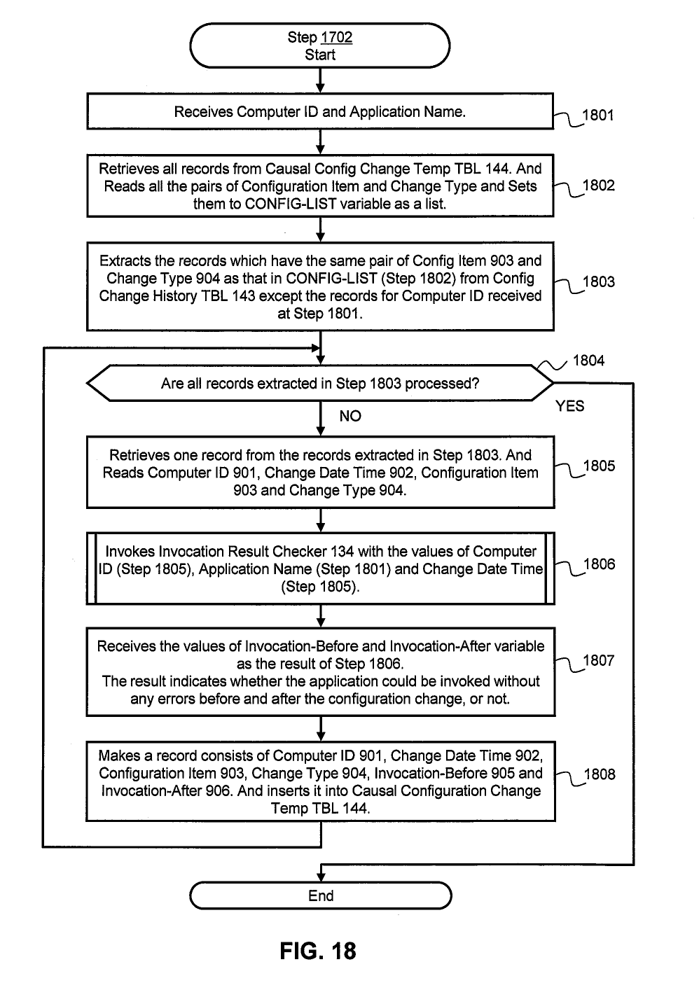

FIG. 17 is an example of a flowchart describing a causal configuration changes analysis process executed by the causal configuration changes analyzer 132 that resides in the analysis computer 101 in accordance with the first embodiment of the present invention. The causal configuration changes analyzer 132 starts the process by being called by the cause analysis program 121. As described in FIG. 17, in Step 1701, the causal configuration changes analyzer 132 receives a computer ID and an application name as parameters. In this explanation, the computer ID is “Comp-001” and the application name is “DOC EDITOR”. In Step 1702, the causal configuration changes analyzer 132 calls the subroutine of FIG. 18 together with the values of the computer ID (Step 1701) and the application name (Step 1701). The records (911 through 971) are stored in the causal configuration changes temporary table 144 at the time of this step. In Step 1703, the causal configuration changes analyzer 132 receives a configuration change list as the return value of Step 1702. The items in this list include the configuration item, the change type, and the change date time. In this explanation, the configuration change list comprises “PRINTER DRIVER A—Added—Jun. 4, 2008 08:20:11”, “PATCH-2322—Added—Jun. 4, 2008 07:43:11”, “VPN-CLIENT v2.0—Added—Jun. 3, 2008 14:27:35”, and “VPN-CLIENT v1.8—Removed—Jun. 3, 2008 13:59:28”.

In Step 1704, the causal configuration changes analyzer 132 checks whether or not all of the items in the list received in Step 1703 have been processed. In the case of a YES, the processing ends. In the case of a NO, the processing proceeds to Step 1705. In Step 1705, the causal configuration changes analyzer 132 fetches one item from the list (Step 1703) and reads the configuration item, the change type and the change date time. In Step 1706, the causal configuration changes analyzer 132 references the causal configuration changes temporary table 144 and counts the number of records that satisfy a condition, such as (configuration item (Step 1705)=configuration item in the table 144), (change type (Step 1705)=change type in the table 144), (Invocation-Before=success in the table 144), and (Invocation-After=failure in the table 144). In Step 1707, the causal configuration changes analyzer 132 references the causal configuration changes temporary table 144 and counts the number of records that satisfy a condition, such as (configuration item (Step 1705)=configuration item in the table 144) and (change type (Step 1705)=change type in the table 144). In Step 1708, the causal configuration changes analyzer 132 inserts the result records in the causal configuration changes table 146. These records include the configuration item (Step 1705), the change type (Step 1705), the change date time (Step 1705), the number of failure records (result of Step 1706), and the number of all related records (result of Step 1707). The records (1011 through 1014) are stored in the causal configuration changes table 146 at the time of this step.

FIG. 18 is an example of a flowchart describing a subroutine of the causal configuration changes analysis process in Step 1702 of FIG. 17. This subroutine starts processing by being called by the causal configuration changes analyzer 132. As described in FIG. 18, in Step 1801, this subroutine receives a computer ID and an application name as parameters. In this explanation, the computer ID is “Comp-001” and the application name is “DOC EDITOR”. In Step 1802, this subroutine fetches all the records from the causal configuration changes temporary table 144. This subroutine also reads all the configuration item and change type pairs, and sets these pairs in a CONFIG-LIST variable as a list. The CONFIG-LIST variables at the time of this step comprise “PRINTER DRIVER A—Added”, “PATCH-2322—Added”, “VPN-CLIENT v2.0—Added”, and “VPN-CLIENT v1.8—Removed”. In Step 1803, this subroutine selects a record comprising the same configuration item 903 and change type 904 pair as that in the CONFIG-LIST (Step 1802) with the exception of the record for the computer ID received in Step 1801 from the configuration change history table 143.

In Step 1804, this subroutine checks whether or not all the records selected in Step 1803 have been processed. In the case of a YES, the processing ends. In the case of a NO, the processing proceeds to Step 1805. In Step 1805, this subroutine fetches one record from the records selected in Step 1803, and reads the computer ID 901, the change date time 902, the configuration item. 903, and the change type 904. In Step 1806, this subroutine calls the invocation result checker 134 together with the values of the computer ID (Step 1805), the application name (Step 1801) and the change date time (Step 1805). In Step 1807, this subroutine receives the values of the Invocation-Before and Invocation-After variables as the result of Step 1806. The result shows whether or not the application was able to be invoked without any errors before and after the configuration change. In Step 1808, this subroutine creates a record comprising the computer ID 901, the change date time 902, the configuration item 903, the change type 904, the invocation-before 905 and the invocation-after 906. The subroutine also inserts this record in the causal configuration changes temporary table 144.

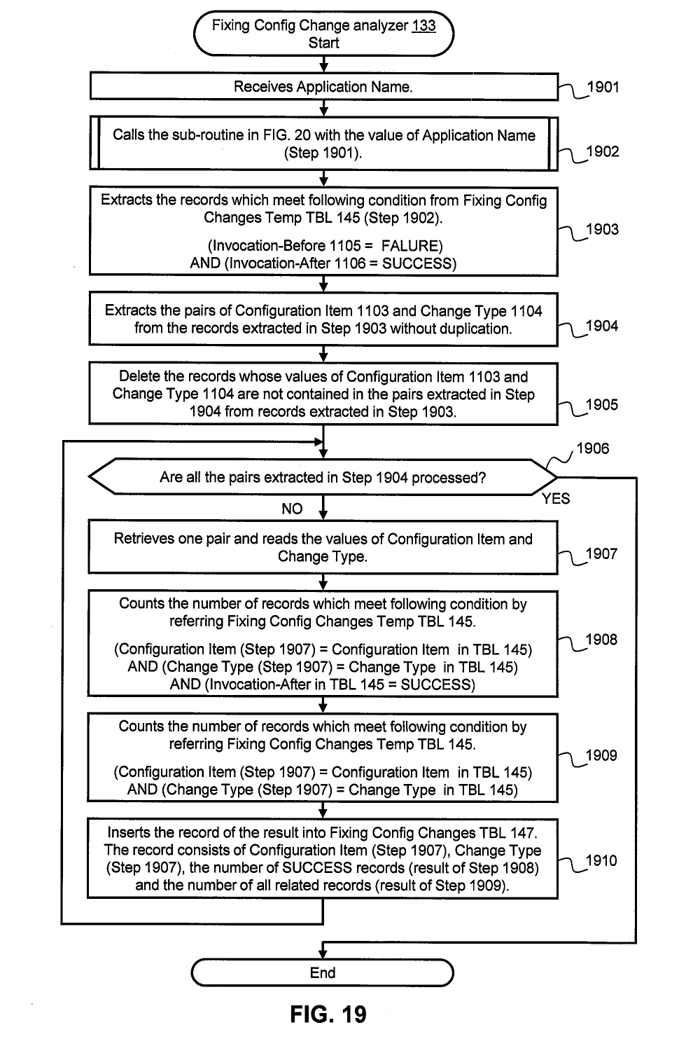

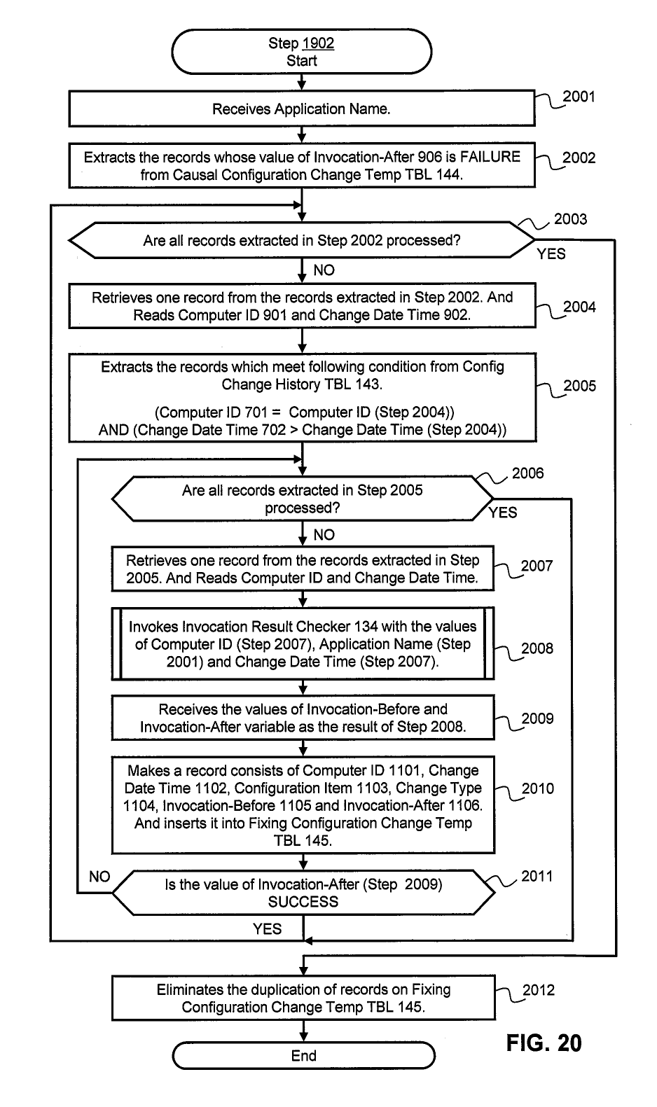

FIG. 19 is an example of a flowchart describing a fixing configuration changes analysis process executed by the fixing configuration changes analyzer 133 that resides in the analysis computer 101. The fixing configuration changes analyzer 133 start processing by being called by the cause analysis program 121. As described in FIG. 19, in Step 1901, the fixing configuration changes analyzer 133 receives an application name as a parameter. In this explanation, the application name is “DOC EDITOR”. In Step 1902, the fixing configuration changes analyzer 133 calls a subroutine of FIG. 20 together with the value of the application name (Step 1901). In Step 1903, the fixing configuration changes analyzer 133 selects a record that satisfies a condition, such as (invocation-before 1105=failure) and (invocation-after 1106=success) from the fixing configuration changes temporary table 145 (Step 1902). In Step 1904, the fixing configuration changes analyzer 133 selects a configuration item 1103 and change type 1104 pair without duplication from the record selected in Step 1903. In Step 1905, the fixing configuration changes analyzer 133 deletes from the records selected in Step 1903 a record, in which the values of the configuration item 1103 and the change type 1104 are not included among the pairs selected in Step 1904.

In Step 1906, the fixing configuration changes analyzer 133 checks whether or not all the pairs selected in Step 1904 have been processed. In the case of a YES, the processing ends. In the case of a NO, the processing proceeds to Step 1907. In Step 1907, the fixing configuration changes analyzer 133 fetches one pair and reads the configuration item 1103 and the change type 1104. In Step 1908, the fixing configuration changes analyzer 133 references the fixing configuration changes temporary table 145 and counts the number of records that satisfy a condition, such as (configuration item (Step 1907)=configuration item in the table 145), (change type (Step 1907)=change type in the table 145), and (Invocation-After =success in the table 145). In Step 1909, the fixing configuration changes analyzer 133 references the fixing configuration changes temporary table 145 and counts the number of records that satisfy a condition, such as (configuration item (Step 1907)=configuration item in the table 145) and (change type (Step 1907)=change type in the table 145). In Step 1910, the fixing configuration changes analyzer 133 inserts the result records in the fixing configuration changes table 147. These records include the configuration item (Step 1907), the change type (Step 1907), the number of success records (result of Step 1908), and the number of all related records (result of Step 1909).

FIG. 20 is an example of a flowchart describing a subroutine of the fixing configuration changes analysis process of Step 1902 of FIG. 19. This subroutine starts the process by being called by the fixing configuration changes analyzer 133. As described in FIG. 20, in Step 2001, this subroutine receives an application name as a parameter. In Step 2002, this subroutine selects a record in which the invocation-after 906 value is failure from the causal configuration changes temporary table 144.

In Step 2003, this subroutine checks whether or not all the records selected in Step 2002 have been processed. In the case of a YES, the processing jumps to Step 2012. In the case of a NO, the processing proceeds to Step 2004. In Step 2004, this subroutine fetches one record from among the records selected in Step 2002, and reads the computer ID 901 and the change date time 902. In Step 2005, this subroutine selects from the configuration change history table 143 a record that satisfies a condition, such as (computer ID 701=computer ID (Step 2004)) and (change date time 702>change date time (Step 2004)).

In Step 2006, this subroutine checks whether or not all the records selected in Step 2005 have been processed. In the case of a YES, the processing moves to Step 2003. In the case of a NO, the processing proceeds to Step 2007. In Step 2007, this subroutine fetches one record from the records selected in Step 2005, and reads the computer ID and the change date time. In Step 2008, this subroutine calls the invocation result checker 134 together with the values of the computer ID (Step 2007), the application name (Step 2001) and the change date time (Step 2007). In Step 2009, this subroutine receives the values of the Invocation-Before and the Invocation-After variables as the result of Step 2008. In Step 2010, this subroutine creates a record comprising the computer ID 1101, the change date time 1102, the configuration item 1103, the change type 1104, the invocation-before 1105 and the invocation-after 1106. This subroutine also inserts this record in the fixing configuration changes temporary table 145. In Step 2011, this subroutine checks whether or not the Invocation-After value (Step 2009) is success. In the case of a YES, the processing returns to Step 2003. In the case of a NO, the processing returns to Step 2006. In Step 2012, this subroutine removes the duplicate of the record in the fixing configuration changes temporary table 145.

### B. Second Embodiment

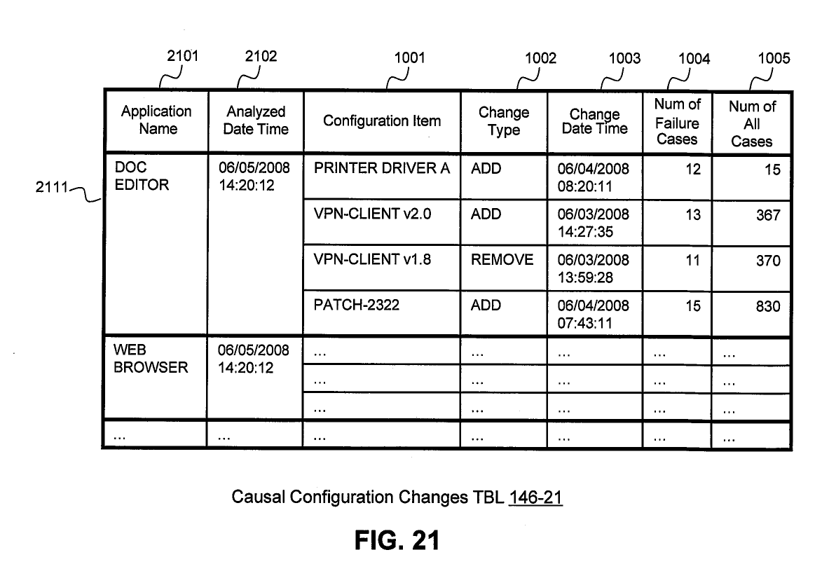

FIG. 21 shows an example of a causal configuration changes table 146-21 in accordance with a second embodiment of the present invention. In the second embodiment, in a case where the same analysis was performed in the past, the cause analysis program 121 reuses and displays the result of the analysis and storage carried out in the past. To do this, the causal configuration changes table 146 of FIG. 10 must be expanded. The columns 1001 through 1005 in FIG. 21 are the same as those in FIG. 10. In addition, new columns for an application name 2101 and an analysis date/time 2102 are introduced. For example, a record 2111 shows that an analysis of the application name “DOC EDITOR” was carried out at the analysis date/time “Jun. 5, 2008 14:20:12”. In a case where the application name is “DOC EDITOR”, and an analysis condition such that the target period detector 131 result be the same is specified, the cause analysis program 121 is able to display the analysis result based on the causal configuration changes table 146-21. This same concept may also be applied to the fixing configuration changes table 147 of FIG. 12.

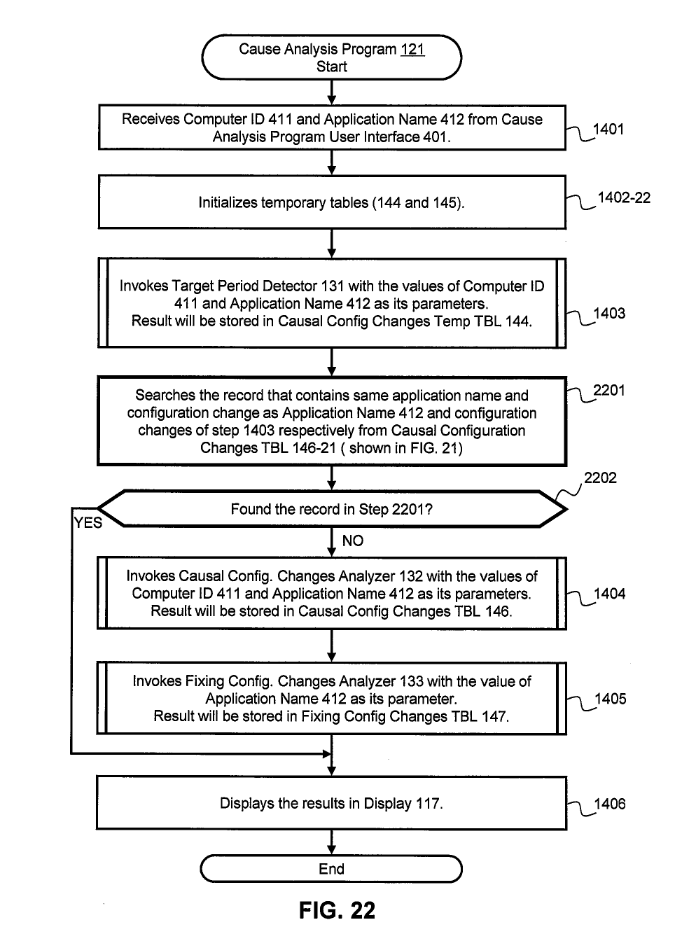

FIG. 22 is an example of a flowchart describing a cause analysis executed by the cause analysis program 121 in accordance with the second embodiment of the present invention. Steps 1401, 1403, 1404, 1405 and 1406 are the same as those in FIG. 14. The differences between FIG. 14 and FIG. 22 are as follows. In Step 1402-22 (instead of Step 1402), the cause analysis program (121) does not initialize the result tables (the causal configuration changes table 146 and the fixing configuration changes table 147). In Step 2201, the cause analysis program 121 searches the causal configuration changes table 146-21 (shown in FIG. 21) for a record comprising the same application name and configuration change as the application name 412 and the configuration change of Step 1403. In Step 2202, the cause analysis program 121 checks whether or not the past result record was found. In the case of a YES, the processing moves to Step 1406. In the case of a NO, the processing proceeds to Step 1404. It is supposed that the result to be stored in Step 1404 is based on a summary of the causal configuration changes table 146-21 (FIG. 21).

### C. Third Embodiment

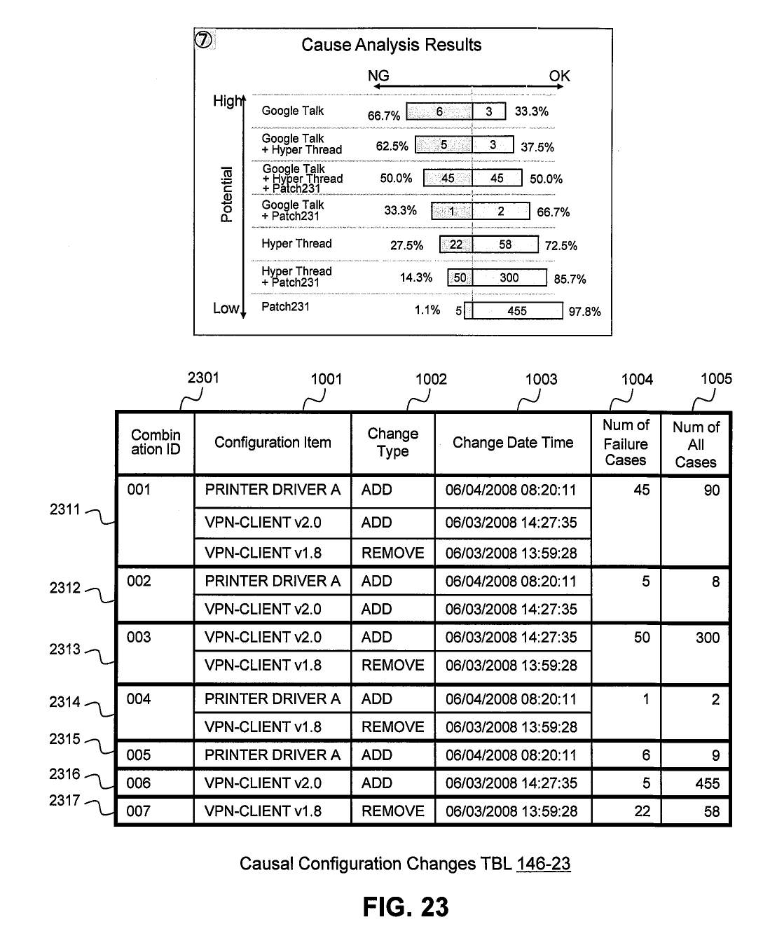

FIG. 23 shows an example of a causal configuration changes table 146-23 in accordance with a third embodiment of the present invention. In the third embodiment, the cause analysis program 121 performs an analysis based on a combination of configuration changes. To do this, the causal configuration changes table 146 of FIG. 10 must be expanded. As shown in FIG. 23, the columns 1001 through 1005 are the same as those in FIG. 10. In addition, a new column for a combination ID 2301 is introduced. Records 2311 through 2317 exist here. For example, the record 2311 shows that an analysis was performed by using all of the combinations of the respective configuration changes. The same concept may be applied to expand the fixing configuration changes table 147 of FIG. 12.

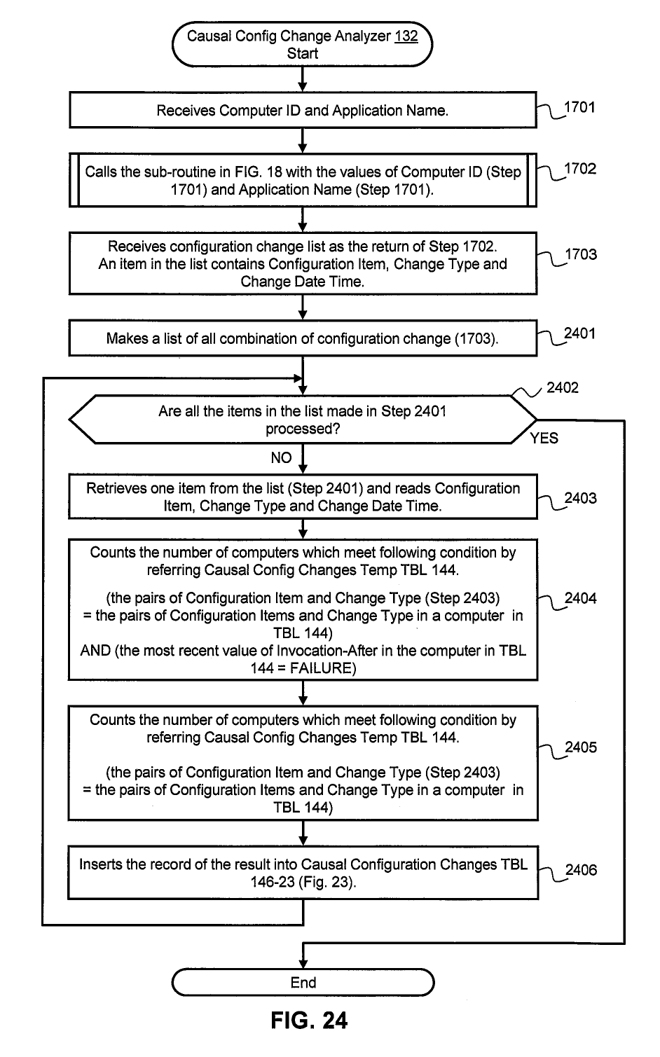

FIG. 24 is an example of a flowchart describing a causal configuration changes analysis process executed by the causal configuration changes analyzer 132 in accordance with the third embodiment of the present invention. Steps 1701, 1702, and 1703 are the same as those in FIG. 17. The differences between FIG. 17 and FIG. 24 are as follows. In Step 2401, the causal configuration changes analyzer 132 creates a list of all the combinations of the configuration change 1703. In a case where the configuration changes are “PRINTER DRIVER A—Added”, “VPN-CLIENT v2.0—Added” and “VPN-CLIENT v1.8—Removed”, the combinations thereof are as follows.
“PRINTER DRIVER A—Added”, “VPN-CLIENT v2.0—Added”, “VPN-CLIENT v1.8—Removed”
“PRINTER DRIVER A—Added”, “VPN-CLIENT v2.0—Added”
“PRINTER DRIVER A—Added”, “VPN-CLIENT v1.8—Removed”
“VPN-CLIENT v2.0—Added”, “VPN-CLIENT v1.8—Removed”
“PRINTER DRIVER A—Added
“VPN-CLIENT v2.0—Added”
“VPN-CLIENT v1.8—Removed”

In Step 2402, the causal configuration changes analyzer 132 checks whether or not all of the items in the list created in Step 2401 have been processed. In the case of a YES, the processing ends. In the case of a NO, the processing proceeds to Step 2403. In Step 2403, the causal configuration changes analyzer 132 fetches one item from the list (Step 2401), and reads the configuration item, the change type, and the change date time. In Step 2404, the causal configuration changes analyzer 132 references the causal configuration changes temporary table 144 and counts the number of computers that satisfies a condition, such as (configuration item and change type pair (Step 2403)=configuration item and change type pair of computer in table 144), and (most recent Invocation-After value of this computer=failure in table 144). In Step 2405, the causal configuration changes analyzer 132 references the causal configuration changes temporary table 144 and counts the number of computers that satisfies a condition, such as (configuration item and change type pair (Step 2403)=configuration item and change type pair of computer in table 144). In Step 2406, the causal configuration changes analyzer 132 inserts the result record into the causal configuration changes table 146-23 (FIG. 23).

### D. Fourth Embodiment

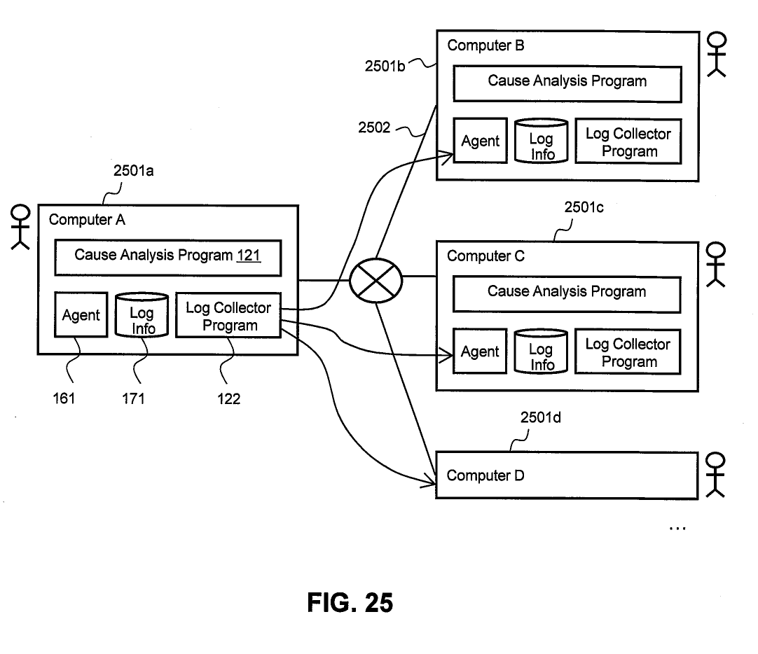

FIG. 25 illustrates an example of the hardware architecture configurations, software modules and tables of the entire system in accordance with a fourth embodiment of the present invention. In the fourth embodiment for a peer-to-peer architecture, all the computers may become a server or a client depending on the circumstances. There is no need for a centralized server. Each computer 2501 comprises a cause analysis program (121), an agent (161), log information (171), and a log collector program (122). The log information (171) in each computer comprises not only the log information of this computer, but also the log information of another computer.

Naturally, the system configuration illustrated in FIGS. 1 and 2 are genuine examples of an information system conceivable by implementing the present invention, but the present invention is not limited to a specific hardware configuration. A computer and storage system that implement the present invention may also comprise a known I/O device (for example, a CD and DVD drive, a flexible disk drive, a hard drive, or the like) that are capable of storing and reading the modules, programs and data structures used to implement the present invention described hereinabove. These modules, programs and data structures may be encoded on these types of computer-readable media. For example, a data structure of the present invention may be stored on a computer-readable medium that is independent of one or multiple computer-readable media on which reside(s) a program that is used by the present invention. The system components may be intercoupled in accordance with an arbitrary digital data communication format or medium, such as, for example, a communication network. Examples of a communication network include a local area network, a wide area network, for example, the Internet, a wireless network, a storage area network, and so forth.

In the explanation, many details are presented for the purpose of providing a complete understanding of the present invention. However, as should be clear to a person having ordinary skill in the art, not all of these specific details are necessary for carrying out the present invention. It should also be noted that the present invention may be described as a process that is generally illustrated as a flowchart, a flow diagram, a structural diagram or a block diagram. The flowchart may describe an operation as a consecutive process, but most operations are able to be executed either in parallel or simultaneously. In addition to this, the order of an operation may be rearranged.

As is widely known in this field, the above-described operations may be executed by hardware, software, or some combination of hardware and software. Various aspects of the embodiments of the present invention may be implemented using circuits and logical devices (hardware), but in a case where another aspect is stored on a machine-readable medium and executed by a processor, this other aspect of the present invention may be implemented by using an instruction (software) that causes the execution of a method for accomplishing the embodiment of the present invention in this processor. In addition, a number of embodiments of the present invention may be executed using only hardware, and another embodiment may be executed using only software. Furthermore, the various functions that have been described may be executed inside a single unit, or may be transferred to a large number of components and distributed using numerous methods. In a case where the present invention is executed using software, it is possible to execute a method by a processor of a general-purpose computer or the like based on an instruction stored on a computer-readable medium. In a preferred case, it is possible to store the instruction on a medium using compression and/or an encrypted format.

From the above, it should be clear that the present invention is a method, an apparatus, and a program stored on a computer-readable medium for finding a solution to an application failure by analyzing a configuration change without using a knowledge database. In addition to this, specific embodiments have been illustrated and described in this specification, but a person having ordinary skill in the art will recognize that an arbitrary combination calculated to achieve the same object can be used in place of the disclosed specific embodiments. This disclosure is intended to protect any and all adaptations or variations of the present invention, and it is assumed that it will be understood that the terminology used in the following claims should not be interpreted as limiting the present invention to the specific embodiments disclosed in the specification. Rather, the scope of the present invention is completely determined by the following claims, which should be interpreted together with the entire scope of equivalents that have the right of the claims in accordance with established claim interpretation theory.

### E. Fifth Embodiment

In a fifth embodiment, an agent in a target computer monitors for application installation, and at the timing at which an installation is detected, notifies an analysis computer of an installation start event. A tabulation program is added to the analysis computer in this embodiment. In a case where an application name corresponds to the notified application in the causal configuration changes table, the tabulation program sends the relevant analysis result to the target computer.

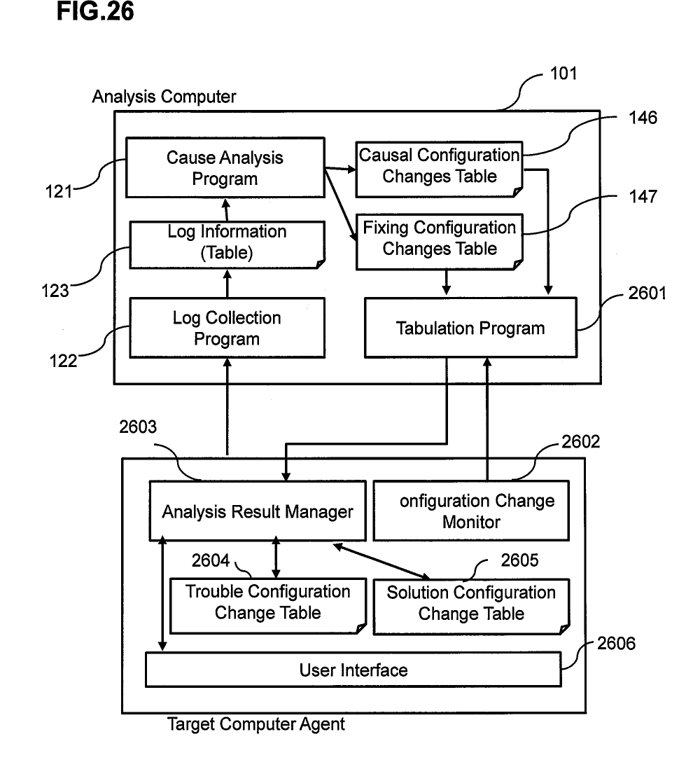

FIG. 26 is a diagram showing a functional block diagram of the agent 161 disposed in the target computer in the fifth embodiment, and a diagram showing a part of the functional block in the analysis computer 101 related to this embodiment. The tabulation program 2601 is added to the functional configuration of the analysis computer shown in FIG. 2. The tabulation program reads and uses the causal configuration changes table 146 and the fixing configuration changes table 147 created by the cause analysis program. Furthermore, the tabulation program 2601 is recorded in the memory 112 of the analysis computer 101, and needless to say is executed by the CPU 111.

The agent 161 has an application monitoring means 2602 for monitoring for and issuing a notification about an application installation, and analysis information management means 2603 for receiving, processing, and storing an analysis result, and performing outputting via a user interface 2606. The received information is saved as a trouble configuration changes table 2604 and a solution configuration changes table 2605.

The flow of processing of the agent program will be explained (not shown in the drawing). Upon detecting the start of an application installation by the invocation of an installer program, the agent program sends to the analysis computer a configuration change event comprising information such as the addition of a relevant application name and change type.

The agent 161, upon receiving analysis result information from the analysis computer, creates and updates the trouble configuration changes table 2604 and/or the solution configuration changes table 2605 based on the analysis result information. Then, the agent 161 creates and outputs a result-based screen.

The agent may halt the application installation process at this point. In accordance with this, a user interface for notifying the user of the cancellation is provided. In a case where an installation is cancelled, the agent waits for the reception of an analysis result, and in a case where nothing is received within a predetermined period of time, resumes the installation process. When a received analysis result is outputted to the screen, together with the message “Continue installation?”, the agent provides a user interface that enables the user to choose to either continue or to cancel the installation.

Next, the trouble configuration changes table 2604 will be explained. The trouble configuration changes table is for showing a configuration change, which has been analyzed by the analysis computer 101 as being a potential problem. The trouble configuration changes table 2604 has the time at which the analysis computer carried out analysis processing for each installation-target (may also include a target that is to be installed in the future) application, and one or more records. Furthermore, the relevant record(s) has/have the following attribute values.
A value showing a configuration change that could be a cause of trouble
A failure rate

Next, the solution configuration changes table 2605 will be explained. The solution configuration changes table shows a configuration change, which has been analyzed by the analysis computer 101 as being a possible solution to the trouble. The solution configuration changes table has the time at which the analysis computer carried out analysis processing for each installation-target (may also include a target that is to be installed in the future) application, and one or more records. Furthermore, the relevant record(s) has/have the following attribute values.
A value showing a configuration change that could solve for application trouble
A success rate

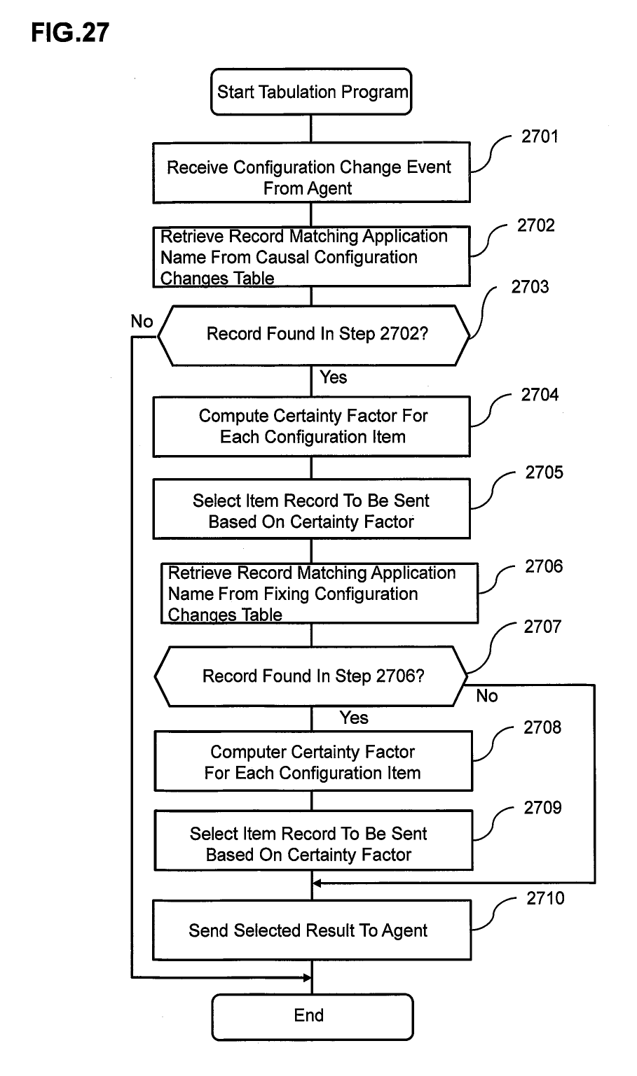

FIG. 27 shows a flowchart of the tabulation program in the analysis computer.

A case in which the analysis result information includes a configuration change that constitutes trouble will be explained below. In this case, the execution of Steps 2706 through 2709 of FIG. 27 will be omitted.

(Step 2701) The tabulation program receives a configuration change event.

(Step 2702) The tabulation program searches the causal configuration changes table for the received application name.

(Step 2703) The tabulation program determines whether or not there is a record with an application name that matches the received application name in accordance with the search of Step 2702.

(Step 2704) The tabulation program computes as the certainty the percentage of the number of failure cases with respect to the total number of cases for each configuration item record.

(Step 2705) The tabulation program next selects a record to be sent based on the certainty.

Then, the tabulation program includes the information of the selected record in the analysis result information, sends this result information to the target computer, which is the source of the configuration change event notification (Step 2710), and ends the processing.

Furthermore, as the selection method of Step 2705, there is a method that uses a threshold, and a method that is limited to a specified number.

(Method 1) In the case of the method that uses a threshold, the tabulation program receives a certainty threshold from either the administrator or the target computer user, and manages this threshold by recording the threshold in the memory 112. The tabulation program compares the certainty with the threshold, and only selects a configuration item record with a certainty that is equal to or greater than the threshold.

(Method 2) In a case that is limited to a specified number, the specified number (for example, 3) is defined beforehand. The tabulation program selects the top three records based on the computed certainty. In a case where the definitions of the threshold and the specified number are NULL, all the records are selected.

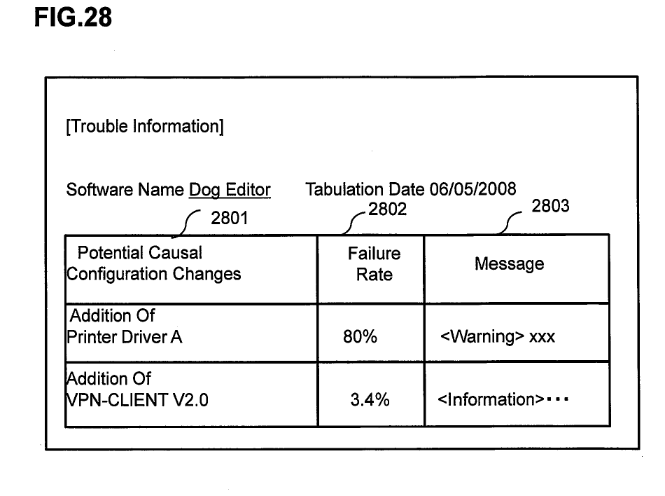

FIG. 28 shows an example of an output in which the agent 161 references the trouble configuration changes table 2604, and displays the results on the display 157 via the video I/F 154. In the upper portion, the tabulation program displays information regarding a configuration item that could be the cause of an invocation failure with respect to the installation-target application. The agent 161 displays a failure rate as a certainty (2802) for each configuration item and its change type (2801), and in addition outputs a message (2803) to the end user according to the certainty. The message accords with the value of the certainty, and, for example, for a certainty of equal to or greater than 75%, is “<Warning> The likelihood of this configuration change resulting in a failed application invocation is high, so please take action”, for a certainty of between 50% and 74%, is “<Caution> There is a possibility that this configuration change will result in a failed application invocation”, and for a certainty of less than 50%, is “<Notification> This configuration change will not affect the application”.

Furthermore, the same as in FIG. 21, not only the information of the causal configuration changes table, but the configuration item, number of fixing cases, and total number of cases for each application name are stored in the table in accordance with the second embodiment for the fixing configuration changes table as well. Steps 2706 through 2709 of FIG. 27 are for realizing this processing.

(Step 2706) The tabulation program searches the fixing configuration changes table and selects the relevant application information.

(Step 2707) The tabulation program determines whether or not the application name record matches the application name searched for Step 2706.

(Step 2708) The tabulation program computes the percentage of the number of failure cases with respect to the total number of cases as the certainty for each configuration item record.

(Step 2709) The tabulation program selects a record to be sent next based on the certainty, and includes this record in the analysis result information.

The agent 161 receives the analysis result information and uses the record included in the analysis result information to create and update the solution configuration changes table. In this embodiment, since the trouble has yet to occur in this application of the target computer, the solution may be to output the trouble information at the same time, or to output the trouble information separately when there is a request from the user interface.

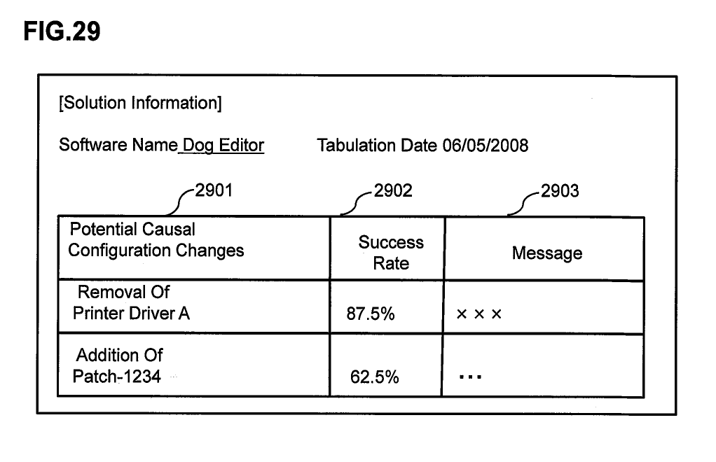

FIG. 29 shows an example of an output in which the agent 161 references the solution configuration changes table 2705 and displays the effectiveness of a solution with respect to the invocation failure of the relevant application on the display 157 via the video I/F 154. The agent 161 displays a solution success rate as a certainty (2902) for each configuration item and its change type (2901), and in addition outputs a message (2903) to the end user according to the certainty. It is supposed that the message, for example, is “This configuration change could fix the application invocation failure trouble”.

As a variation of the fifth embodiment, a method based on the configuration of the configuration change event source computer will be explained as the method for selecting the record to be sent instead of the method based on the certainty. The processing up to Step 2703 is the same, and the record that matches the application name in the causal configuration changes table is selected. Next, the tabulation program references the configuration change history table shown in FIG. 7, and searches for records with respect to each configuration item and change type in the record(s) selected in the above-mentioned Step 2703 for the record in which the computer ID matches the source computer. It is supposed that the record to be sent is only that record in which the configuration item and change type match.

The selection of these records to be sent is carried out to provide the minimal amount of information required. It is possible to reduce the traffic to the target computer by deleting information related to a low certainty and a configuration item that is not related to the configuration of the relevant computer.

In addition, as another example of the fifth embodiment, a method for providing information not only when an application is installed, but also at the time of a configuration item change, such as the application of a patch or the removal of a piece of software will be explained. The agent not only monitors for an application installation, but also for configuration item changes such as the application of a patch or the updating or removal of a driver, and upon detection thereof, notifies the analysis computer of a configuration change event. Here, configuration items are included as the application name, and change types such as addition and removal are included in the configuration change event.

In the first embodiment, the addition of a patch or the removal of a software program is recorded in the causal configuration changes table as a configuration item that constitutes a causal candidate for another application invocation failure. Accordingly, the tabulation program receives a configuration change event, and in a case where a search of the causal configuration changes table for the received application name in the flow of processing shown in FIG. 27 fails to find a record of the application name, searches for a configuration item. In addition, the tabulation program also searches for a configuration item that matches the change type, selects this record and sends same to the agent.

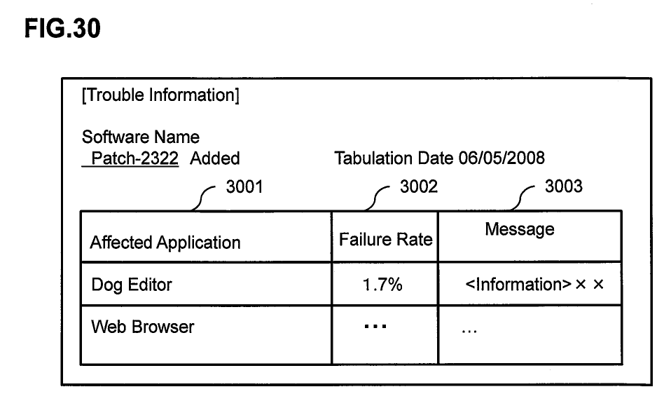

FIG. 30 shows the screen output information of the target computer in this case. For each configuration item and change type that will have an affect (3001), a solution success rate is displayed as a certainty (3002), and, in addition, a message (3003) is outputted to the end user with respect to the software name that is the configuration change target.

The same concept may be applied to the fixing configuration changes table as well.

As another variation, a method for using the information of the causal configuration changes table in which configuration items are combined will be explained. The result of an analysis carried out based on a combination of configuration changes, which was shown in the third embodiment, is stored in the causal configuration changes table shown in FIG. 23. The table of FIG. 23 is expanded at this point, and columns for an application name and analysis date/time are introduced (not shown in the drawing). When the result of the causal configuration changes analysis of FIG. 24 is stored, the target application name and the date and time of the analysis are stored.

The point in the processing of the tabulation program in this example that differs from the flow of processing shown in FIG. 27 is the fact that the expanded causal configuration changes table of FIG. 23 is searched instead of searching the causal configuration changes table of FIG. 21 in Step 2702. A record in which the application name is a match is selected from the expanded causal configuration changes table, and the number of failure cases with respect to the total number of cases is computed as the certainty for each of these combination IDs. The combination ID record to be sent is determined based on the certainty.

### F. Sixth Embodiment

In a fifth embodiment, there is a previous cause analysis request with relation to a relevant application, and when an analysis is carried out, the result thereof is provided to the end user of the target computer. In a case where an analysis is not carried out at this point or to provide the latest analysis result, the method in this embodiment is such that an analysis is executed at the point in time at which a configuration change event is received, and the end user is provided with this result.

Rather than an analysis subsequent to an application invocation failure in the analysis target computer, and analysis is performed as to whether there is case in which there was trouble when invoking an application in another computer in a case where the relevant application was installed.

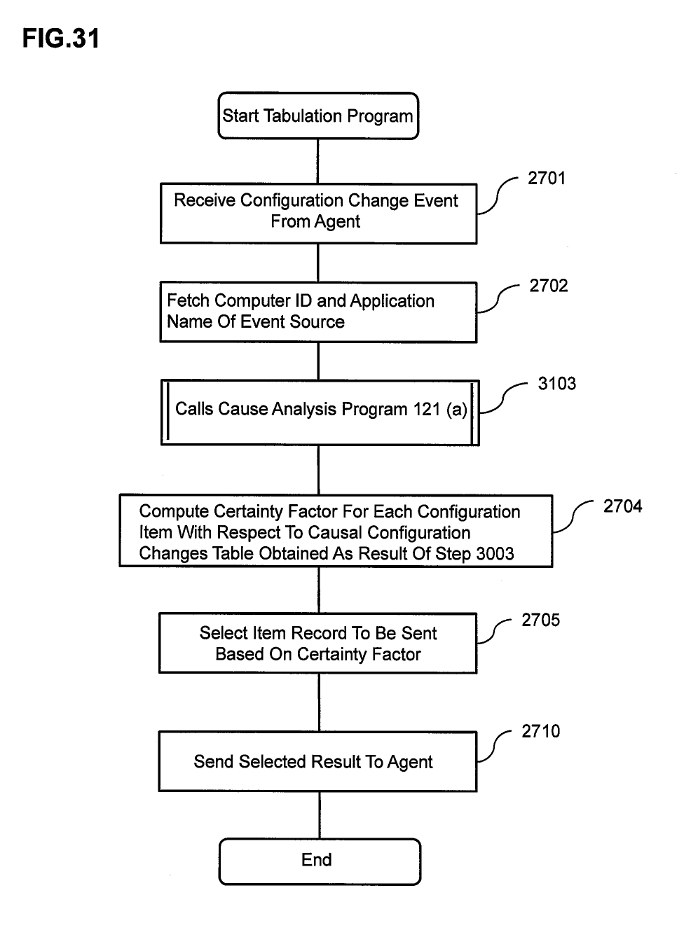

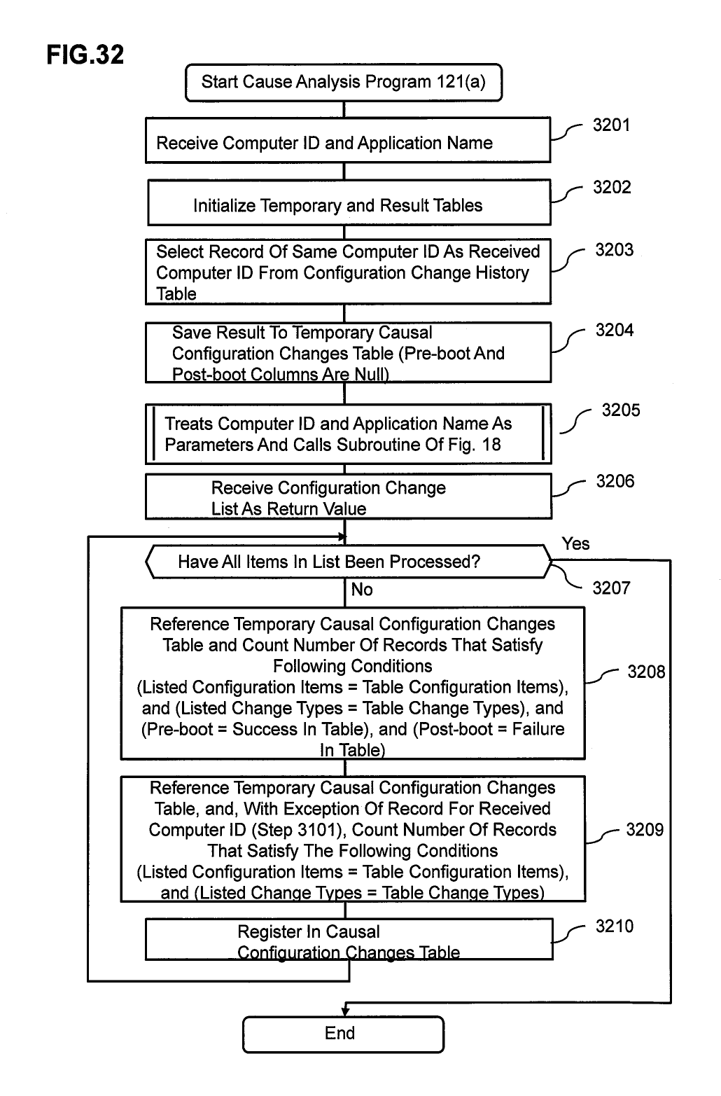

FIG. 31 is an example of a flowchart of processing executed by the tabulation program in the analysis computer in the sixth embodiment of the present invention. The tabulation program receives an installation start event notification from the agent (Step 2701), and fetches the application name that is included in the source computer ID and in the notification (Step 2702) the same as in FIG. 27. Next, the tabulation program treats the computer ID and application name as parameters and calls the cause analysis program 121(a) (Step 3103). A portion of the processing of the cause analysis program here differs from the processing on FIG. 14 in the first embodiment, and this processing will be explained using FIG. 32.

After the cause analysis program 121(a) has ended, the tabulation program computes the number of failure cases with respect to the total number of cases as the certainty for each configuration item (Step 2704) for the causal configuration changes table obtained as the result of the analysis, selects the record to be sent based on the certainty (Step 2705), and sends this record to the agent (Step 2710) the same as in the fifth embodiment.

Furthermore, the cause analysis program 121(a) may create a fixing configuration changes table the same as in the first embodiment. In accordance with this, the certainty is also computed, the record to be sent is determined based on the certainty, and the record is sent to the agent in the same way for the fixing configuration changes table obtained as an analysis result.

FIG. 32 shows a flowchart of the cause analysis program 121(a) of this embodiment.

(Step 3201) The cause analysis program receives a computer ID and an application ID from the tabulation program.

(Step 3202) The cause analysis program initializes the temporary and result tables.

(Step 3203) Next, the cause analysis program reads the configuration change history table and selects the record of the same computer ID as the received computer ID. In a case where the data in the configuration change history table has been stored for a long period of time, the selection target may be limited to a record up to a specified period of time prior to this.

(Step 3204) The cause analysis program stores the selection result in the causal configuration changes temporary table. Since an invocation check is not carried out with respect to this computer ID, the Invocation-Before and Invocation-After columns of the stored record remain NULL.

(Step 3205) Next, the cause analysis program analyzes the cases of the other target computers. Since the analysis processing is the same as that of the first embodiment, the subroutine of FIG. 18 is called here.

(Step 3206) The cause analysis program receives a configuration change list as the return value of the subroutine. The items in this list include the configuration item, the change type, and the change date time.

(Step 3207) The cause analysis program checks whether or not all the items in the list have been processed. In a case where all the items have not been processed, the program proceeds to Step 3208.

(Step 3208) The cause analysis program references the result of the subroutine (Step 3205) and the created causal configuration changes temporary table, and counts the number of records that satisfies the following conditions. It is supposed that the conditions are that the configuration item and change type of the configuration change list be the same as the configuration item and change type of the table, and, in addition, that the “Invocation-Before=success” and the “Invocation-After =failure”.

(Step 3209) The cause analysis program references the causal configuration changes temporary table, and, with the exception of the record with respect to the computer ID received in Step 3201, counts the number of records in which the configuration item and change type of the configuration change list are the same as the configuration item and change type of the table.

(Step 3210) The cause analysis program registers the result record in the causal configuration changes table. The causal configuration changes table has the table configuration shown in FIG. 21, and registers the application name received in Step 3201, the analysis date/time, the configuration item, change type, and change date time included in the configuration change list (Step 3206), the value of the count of Step 3208 as the number of failure cases, and the value of the count of Step 3209 as the total number of cases.

As a variation of the sixth embodiment, in a case where a causal configuration changes table for the relevant application already exists, the information of this table is used without carrying out a new analysis provided that this information is not equal to or greater than a specified period of time prior based on the analysis date/time. In accordance with this, after Step 2702 in the processing of the tabulation program shown in FIG. 31, the causal configuration changes table is searched, and in a case where the relevant application record is found, confirms the analysis date and time. In a case where the analysis date and time fall within a specified period of time, the corresponding record is used and the computation of the certainty for each configuration item and subsequent processing (Steps 2704 through 2706) is carried out without calling the cause analysis program. In a case where the analysis date and time do not fall within the specified period of time, processing proceeds to Step 3103.

As a variation of either the fifth or sixth embodiment, a method for outputting data held by the agent will be explained. The trouble configuration changes table and the solution configuration changes table, which are received from the analysis computer and saved, comprise either a causal configuration item or a fixing configuration item and the certainty therefor for each application. The agent provides a user interface for receiving an application name input, and when the user inputs this application name, searches the table for the information related to this application, and in a case where the information exists, outputs this information as in the examples shown in FIG. 28 and FIG. 29.

Furthermore, as another sixth embodiment, there is a method for regularly invoking the tabulation program and updating information in the analysis computer. Unlike the processing of FIG. 31, the tabulation program does not receive a computer ID and an application name when it is invoked. For this reason, the tabulation program fetches the application names in the stored causal configuration changes table, selects the configuration change items subsequent to the previous analysis date/time for each computer with respect to all the applications, and implements a cause analysis. The tabulation program updates the causal configuration changes table with the regularly tabulated information, stores same, and sends same to the target computer either regularly or when a configuration change event is received or there is a request from the agent.

There is a method for carrying out an analysis of an application invocation failure case affected by a user operation in cases other than a configuration change, such as the installation of an application or the application of a patch. In accordance with this, the log collection program of the analysis computer collects a user operation log, and manages this log using an operation history table. The agent uses configuration change monitoring means to monitor for a user operation, such as an OS setting change, and in a case where a specific operation has occurred, notifies the analysis computer. The tabulation program and the cause analysis program in the analysis computer search the operation history table, analyze a case in which an application invocation failure occurred subsequent to performing a similar operation, and tabulate a certainty. The result is sent to the agent, and the agent outputs this result to a screen.

In accordance with the above, it is possible to provide, at the time when the end user carries out a configuration change, an analysis result with respect to application trouble caused by a configuration change in the computer using an analysis computer without using a knowledge database, and to realize support for urging the end user to deal with the trouble.

In the above fifth and sixth embodiments, it was explained that in an application implementation method in the computer system comprising multiple target computers and an analysis computer, one or more first target computers, which are included in the multiple target computers and in which a predetermined application has been installed and invoked, send a log comprising information of multiple configuration changes that have been made prior to invoking the predetermined application to the analysis computer, and the analysis computer receives the log and computes, for each type of configuration change and based on the log, an invocation failure rate which is a percentage at which the invocation of the predetermined application fails subsequent to the configuration change.

Furthermore, it was explained that a second target computer, which is included in the multiple target computers and is a target computer other than the one or more first target computers: (1) receives, from the analysis computer, first information comprising an invocation failure rate for each type of configuration change related to the predetermined application, and (2) based on the invocation failure rate, displays the type of configuration change that is the cause of the failure of the predetermined application invocation.

Furthermore, it was explained that the invocation failure rate included in the first information is an invocation failure rate for each type of part of all the types of configuration change that detected by the analysis computer based on the log, and that the part of types may be selected by the analysis computer based on the invocation failure rate.

Further, it was explained that the analysis computer computes, for each type of configuration change and based on the log, an invocation success rate which is a percentage at which the invocation of the predetermined application succeeds subsequent to the configuration change, and the second target computer (3) receives, from the analysis computer, second information comprising an invocation success rate for each type of configuration change related to the predetermined application, and (4) based on the invocation success rate, may display the type of configuration change that is the cause of the successful invocation of the predetermined application.

Furthermore, it was explained that the second target computer may have multiple applications installed besides the predetermined application, and the second target computer may select, from among the predetermined application and the multiple applications, an application for which the invocation could fail with respect to a predetermined type included in all the configuration change types, and display an identifier of the selected application.

Furthermore, it was explained that the type is an example of a configuration item and/or a change type, but another example might be a configuration change operation type.

Furthermore, in the above explanation, the information of the present invention has been explained by using expressions such as “aaa table”, “aaa list”, “aaa DB”, and “aaa queue”, but this information may also be expressed using a data structure other than a table, list, DB, or queue. For this reason, “aaa table”, “aaa list”, “aaa DB”, and “aaa queue” may also be called “aaa information” to indicate that the information is not dependent on the data structure. In addition, the expressions “identification information”, “identifier”, “name” and “ID” have been used when explaining the content of the respective information, but these expressions are interchangeable.

Furthermore, the analysis computer may be multiple computers. The memory 152 and disk 153 of the target computer 102 may be lumped together as a storage resource (that is, a storage device) without making a distinction between the two. Similarly, the memory 112 and the disk 113 of the analysis computer 101 may also be lumped together as a storage resource without making a distinction between the two.

Furthermore, in the above explanation, there were cases in which the explanation was given with “program” as the subject, but since a process, which is determined by a program being executed by a processor, is carried out while using a memory and a communication port (a communication control device), the explanation may also be given by using the processor as the subject. Further, a process that has been disclosed as having a program as the subject may be a process that is carried out by a management server or other such computer, or an information processing apparatus. In addition, either all or a portion of a program may be realized using dedicated hardware.

Furthermore, the respective types of programs may be installed in the respective computers using a program delivery server or a computer-readable storage media.

### REFERENCE SIGNS LIST

101 Analysis computer
102 Analysis target computer
103 LAN
111 CPU
112 Memory
113 Disk
114 Video interface
115 Network interface
116 System bus
117 Display
121 Cause analysis program
122 Log collector program
123 Log information
131 Target period detector
132 Causal configuration changes analyzer
133 Fixing configuration changes analyzer
134 Invocation result checker
141 Event log table
142 Application invocation history table
143 Configuration change history table
144 Causal configuration changes temporary table
145 Fixing configuration changes temporary table
146 Causal configuration changes table
146-21 Causal configuration changes table
146-23 Causal configuration changes table
147 Fixing configuration changes table
151 CPU
152 Memory
153 Disk
154 Video interface
155 Network interface
156 System bus
157 Display
161 Agent
171 Log information

1. An application implementation method in a computer system, which comprises multiple target computers and an analysis computer,
wherein one or more first target computers, which are included in the multiple target computers and in which a predetermined application has been installed and invoked, send a log comprising information of multiple configuration changes that have been made prior to invoking the predetermined application to the analysis computer;
the analysis computer receives the log and computes, for each type of configuration change and based on the log, an invocation failure rate which is a percentage at which the invocation of the predetermined application fails subsequent to the configuration change;
a second target computer which is included in the multiple target computers and is a target computer other than the one or more first target computers:
(1) receives, from the analysis computer, first information comprising an invocation failure rate for each type of configuration change related to the predetermined application; and
(2) based on the invocation failure rate, displays the type of configuration change that is the cause of the failure of the predetermined application invocation.

2. An application implementation method according to claim 1,
wherein the invocation failure rate included in the first information is an invocation failure rate for each type of part of all the types of configuration changes detected by the analysis computer based on the log, and
wherein the part of types is selected by the analysis computer based on the invocation failure rate.

3. An application implementation method according to claim 2,
wherein a tabulation time for showing when the invocation failure rate is computed, is included in the first information, and
wherein the second target computer displays the tabulation time.

4. An application implementation method according to claim 3,
wherein the analysis computer computes, for each type of configuration change and based on the log, an invocation success rate which is a percentage at which the invocation of the predetermined application succeeds subsequent to the configuration change, and
wherein the second target computer:
(3) receives, from the analysis computer, second information comprising an invocation success rate for each type of configuration change related to the predetermined application; and
(4) based on the invocation success rate, displays the type of configuration change that is the cause of the successful invocation of the predetermined application.

5. An application implementation method according to claim 4,
wherein the second target computer is installed with multiple applications besides the predetermined application, and
wherein the second target computer selects, from among the predetermined application and the multiple applications, an application for which the invocation could fail with respect to a predetermined type included in all the types of configuration changes, and displays an identifier of the selected application.

6. An application implementation method according to claim 5,
wherein the processing of the (1) is executed in relation to the installation of the predetermined application.

7. An application implementation method according to claim 6,
wherein the type is a configuration item and/or a change type.

8. A second target computer, which is coupled to an analysis computer for managing a first target computer in which a predetermined application has been invoked, comprising:
a CPU for receiving, from the analysis computer, first information which comprises an invocation failure rate for each type of configuration change related to the predetermined application; and
a display for displaying, based on the invocation failure rate, a configuration change type that is the cause of the failure of the predetermined application invocation,
wherein the invocation failure rate is a value computed, for each type of multiple configuration changes carried out by the first target computer prior to the predetermined application invocation, by the analysis computer as a percentage at which the invocation of the predetermined application fails subsequent to the configuration change.

9. A second target computer according to claim 8,
wherein the invocation failure rate included in the first information is an invocation failure rate for each type of part of all the types of configuration changes detected by the analysis computer, and
wherein the part of types is selected by the analysis computer based on the invocation failure rate.

10. A second target computer according to claim 8,
wherein a tabulation time for showing when the invocation failure rate is computed is included in the first information, and
wherein the second target computer displays the tabulation time.

11. A second target computer according to claim 8,
wherein the analysis computer computes, for each type of configuration change, an invocation success rate which is a percentage at which the invocation of the predetermined application succeeds subsequent to the configuration change,
wherein the CPU receives, from the analysis computer, second information comprising an invocation success rate for each type of configuration change related to the predetermined application, and
wherein, based on the invocation success rate, the display displays the type of the configuration change that is the cause of the successful invocation of the predetermined application.

12. A second target computer according to claim 8,
wherein the second target computer is installed with multiple applications besides the predetermined application,
wherein the CPU selects, from the predetermined application and the multiple applications, an application for which the invocation could fail with respect to a predetermined type included in all the types of configuration changes, and
wherein the display displays an identifier of the selected application.

13. A second target computer according to claim 8,
wherein the displaying on the display is executed in relation to the installation of the predetermined application.

14. A second target computer according to claim 8,
wherein the type is a configuration item and/or a change type.
